(19) United States
(12) Patent Application Publication
(10) Pub. No.: US 2010/0011889 A1
(43) Pub. Date: Jan. 21, 2010

(54) HANDHELD POWDER HANDLING DEVICES AND RELATED METHODS

(75) Inventor: Anthony V. Lemmo, Mission Viejo, CA (US)

Correspondence Address: KNOBBE MARTENS OLSON & BEAR LLP, 2040 MAIN STREET, FOURTEENTH FLOOR, IRVINE, CA, 92614, US

(73) Assignee: BIODOT, INC., Irvine, CA (US)

(21) Appl. No.: 12/174,571

(22) Filed: Jul. 16, 2008

(51) Int. Cl. G01F 11/40; G01N 1/02; G01F 11/00

(52) U.S. Cl. 73/864.34; 73/864.83; 222/287; 222/282; 222/309; 73/864.31; 73/864.73

(57) ABSTRACT

Handheld solid powder sampling and dispensing devices and methods thereof are disclosed. The handheld device has an ergonomically contoured outer surface to be held by a user. Actuation of an outer member of the device causes a predetermined quantity of a powder to be loaded within the device. Actuation of a plunger mechanism causes the predetermined quantity of powder to be dispensed. The outer member and the plunger mechanism are independently operable. Advantageously, the target delivery quantity of powder can be varied by a device adjustment mechanism.

### BACKGROUND OF THE INVENTION

1. Field of the Invention

The invention relates generally to solid handling or manipulating and, more particularly, to handheld devices for solid powder sampling or aspirating and non-contact delivery or dispensing of small amounts of dry solid powders, and methods thereof.

2. Description of the Related Art

There continues to be an increase in demand for the discovery, development and optimization of new materials. These new materials cover the range from polymers, adhesives, and pharmaceuticals all the way to catalysts, phosphors and semiconductors, among others.

A variety of methods and devices exist for obtaining and dispensing small amounts of liquids that have found use in a variety of applications. However, few methods and devices exist for accurately, precisely and/or efficiently manipulating small amounts of solids (e.g., powders), for example, in the milligram range or lower. In the laboratory, such small amounts of solids are often dispensed by hand using a scale. Unfortunately, such conventional methods can be tedious, time consuming, and prone to error.

This disadvantageously not only reduces process efficiency but also undesirably adds to the cost. Moreover, it is a difficult task to effectively utilize small quantities of solids, such as powders, when complex steps to precisely handle, transfer, deliver and process such small quantities are entailed.

### SUMMARY OF THE INVENTION

Dispensing solid materials in the solid state, such as dry powders, has been a challenge for automation for years. Solid dispensing of samples with a wide range of properties has proven even more difficult. To further complicate matters, many applications and experiments involve sample mass in the microgram range. Some examples include pre-formulation studies (e.g., polymorph determination, salt selection), material compatibility, compound management and logistics, formulation optimization, and stability and forced degradation. The powder handling embodiments disclosed herein are ideally suited for these applications and experiments, among others.

Advantageously, some embodiments provide user-friendly versatile and adaptable apparatuses, devices, systems and kits comprising a handheld powder handling device, that avoid the high cost associated with automated systems, but still provide for efficient and accurate sampling and dispensing of powders. Certain embodiments involve methods that utilize such apparatuses, devices, systems and kits to efficiently and accurately sample and dispense powders in a user-friendly manner, while providing for versatile and adaptable operation.

In some embodiments, handheld powder handling devices provide for sampling and dispensing of substantially fixed powder volumes and therefore fixed masses. Most users would utilize a series of such devices directed to typical or custom selected powder masses. In some embodiments, handheld powder handling devices incorporate a range of volume (mass) adjustability. In some embodiments, handheld powder handling devices are designed with a removable probe or tip so customized fabrication can provide probes or tips of varying lengths and of varying material compatibility.

In some handheld powder handling embodiments, a first element or member and a second element or member are provided. The elements or members are independently operable or actuable. Actuation or operation of the first element or member causes a predetermined quantity of powder to be sampled, aspirated or loaded. Actuation or operation of the second element or member causes the predetermined quantity of powder to be dispensed or delivered. The elements or members can comprise part of a handheld device, apparatus, system or kit.

Some embodiments provide a handheld powder dispensing device that generally comprises a surface, a tip, a push button and a plunger. The surface is configured to be held by a user during operation of the device. The tip comprises a lumen and an orifice at an end thereof. The push button is configured to be actuated by the user. The plunger is operatively coupled to the push button and is moveable within the lumen. Desirably, motion of the surface relative to the plunger causes a predetermined amount of powder to be loaded within the lumen and motion of the plunger relative to the surface causes the powder to be ejected from the orifice.

Some embodiments provide a method of handling a powder using a handheld device. The method generally comprises manually holding a surface of the device. A tip of the device is inserted in a powder source. The surface is pushed so that it moves relative to the tip and so that a predetermined quantity of powder is loaded in the tip. A plunger of the device is manually actuated so that it moves within the tip to eject the predetermined quantity of powder from the tip onto or into a target.

Some embodiments relate to a handheld solid powder sampling and dispensing device The handheld device has an ergonomically contoured outer surface to be held by a user. Actuation of an outer member of the device causes a predetermined quantity of a powder to be loaded within the device. Actuation of a plunger mechanism causes the predetermined quantity of powder to be dispensed. The outer member and the plunger mechanism are independently operable. Advantageously, the target delivery quantity of powder can be varied by a device adjustment mechanism (and/or to some degree by a powder compaction process).

For purposes of summarizing the invention, certain aspects, advantages and novel features of the invention have been described herein above. Of course, it is to be understood that not necessarily all such advantages may be achieved in accordance with any particular embodiment of the invention. Thus, the invention may be embodied or carried out in a manner that achieves or optimizes one advantage or group of advantages as taught or suggested herein without necessarily achieving other advantages as may be taught or suggested herein.

All of these embodiments are intended to be within the scope of the invention herein disclosed. These and other embodiments of the invention will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

Having thus summarized the general nature of the invention and some of its features and advantages, certain preferred embodiments and modifications thereof will become apparent to those skilled in the art from the detailed description herein having reference to the figures that follow, of which:

FIG. 1 is a simplified perspective view of a handheld powder handling device illustrating features and advantages in accordance with certain embodiments of the invention.

FIG. 2 is a simplified side or front elevational view of the handheld powder handling device of FIG. 1 illustrating features and advantages in accordance with certain embodiments of the invention.

FIG. 3 is simplified sectional view of the handheld powder handling device of FIG. 1 illustrating features and advantages in accordance with certain embodiments of the invention.

FIG. 4 is simplified partial perspective view of the handheld powder handling device of FIG. 1 with a color coded cap system and an exemplary related Table illustrating features and advantages in accordance with certain embodiments of the invention.

FIG. 5 is a simplified perspective view of the handheld powder handling device of FIG. 1 and a storage case for the illustrating features and advantages in accordance with certain embodiments of the invention.

FIG. 6 is a simplified perspective view of the handheld powder handling device of FIG. 1 and a shipping box for the same illustrating features and advantages in accordance with certain embodiments of the invention.

FIG. 7 is a simplified perspective view of a plurality of handheld powder handling devices comprising different probe sizes and a holder rack for the same illustrating features and advantages in accordance with certain embodiments of the invention.

FIG. 8 is a simplified perspective view of an adjustable fill volume handheld powder handling device illustrating features and advantages in accordance with certain embodiments of the invention.

FIG. 9 is a simplified perspective view of an adjustable fill volume and pneumatically actuated handheld powder handling device illustrating features and advantages in accordance with certain embodiments of the invention.

FIG. 10 is a simplified perspective view of a removable probe interface with a powder handling device illustrating features and advantages in accordance with certain embodiments of the invention.

FIG. 11 is a simplified perspective view of the removable probe of FIG. 10 operatively coupled to a probe housing illustrating features and advantages in accordance with certain embodiments of the invention.

FIG. 12 is a simplified schematic view of plurality of powder handling removable handheld probes comprising different sizes and a holder rack for the same illustrating features and advantages in accordance with certain embodiments of the invention.

FIG. 13 is a simplified perspective view of a vial holder assembly having features and advantages in accordance with certain embodiments of the invention.

FIG. 14 is a simplified side view of the vial holder assembly of FIG. 13 illustrating features and advantages in accordance with certain embodiments of the invention.

FIG. 15 is a simplified top view of the vial holder assembly of FIG. 13 illustrating features and advantages in accordance with certain embodiments of the invention.

FIG. 16 is a simplified sectional view along line 16-16 of FIG. 15 illustrating features and advantages in accordance with certain embodiments of the invention.

FIG. 17 is a simplified enlarged view along line 17-17 of FIG. 16 illustrating features and advantages in accordance with certain embodiments of the invention.

FIGS. 18-20 are simplified perspective views of a powder source or vial assembly illustrating features and advantages in accordance with certain embodiments of the invention.

FIGS. 21A-21C are sectional views of a handheld powder handling device in various stages of operationally sampling and dispensing a powder illustrating features and advantages in accordance with certain embodiments of the invention.

FIG. 22 is a simplified flowchart of a powder handling process or method illustrating features and advantages in accordance with certain embodiments of the invention.

FIG. 23 is a simplified overview of a powder handling process or method illustrating features and advantages in accordance with certain embodiments of the invention.

FIG. 24 is a simplified overview of some operational steps for handling a powder illustrating features and advantages in accordance with certain embodiments of the invention.

FIG. 25 is a simplified image of example powder plugs of different masses as dispensed from the powder handing devices disclosed herein illustrating features and advantages in accordance with certain embodiments of the invention.

FIG. 26 is a graphical representation of replicated experimental results showing delivered powder mass versus various different types of powder materials illustrating features and advantages in accordance with certain embodiments of the invention.

FIG. 27 is a tabulated data chart corresponding to the powders dispensed in accordance with the graphical representation of FIG. 26 illustrating features and advantages in accordance with certain embodiments of the invention.

FIG. 28 is a graphical representation of replicated experimental results showing delivered powder mass versus various different types of powder materials illustrating features and advantages in accordance with certain embodiments of the invention.

FIG. 29 is a tabulated data chart corresponding to the powders dispensed in accordance with the graphical representation of FIG. 28 illustrating features and advantages in accordance with certain embodiments of the invention.

FIGS. 30-34 are respective simplified schematic views of certain processes or methods involving: (i) salt selection; (ii) compatibility experiments; (iii, iv) solubility experiments; and (v) dosing studies having efficacy with certain embodiments of the invention.

FIG. 35 is a simplified schematic view of a liquid handling system which can be used with the disclosed powder handling systems illustrating features and advantages in accordance with certain embodiments of the invention.

FIG. 36 and 37 are simplified schematic views of a liquid handling system which can be used with the disclosed powder handling systems illustrating features and advantages in accordance with certain embodiments of the invention.

### DETAILED DESCRIPTION OF THE PREFERRED EMBODIMENTS

The preferred embodiments of the invention described herein relate generally to solid handling or manipulating and, in particular, to handheld devices for solid powder sampling or aspirating and non-contact delivery or dispensing of small amounts of dry powders or solids, and methods thereof.

While the description sets forth various embodiment specific details, it will be appreciated that the description is illustrative only and should not be construed in any way as limiting the invention. Furthermore, various applications of the invention, and modifications thereto, which may occur to those who are skilled in the art, are also encompassed by the general concepts described herein.

As used herein, powder handling or manipulation includes, without limitation, sampling, aspirating, compressing, compacting, changing bulk density or void fraction, changing powder structure, changing powder particle size, dispensing, delivering, moving, mixing or combining one or more powders, mixing or combining one or more powders with one or more liquids, among others.

Embodiments of the invention can be efficaciously utilized to deliver or dispense powders comprising a wide range of masses. In one embodiment, the mass of powder delivered or dispensed is in the range from about 1 microgram (μg) to about 1,000 milligrams (mg), including all values and sub-ranges therebetween. In another embodiment, the mass of powder delivered or dispensed is in the range from about 10 micrograms (μg) to about 500 milligrams (mg), including all values and sub-ranges therebetween. In yet another embodiment, the mass of powder delivered or dispensed is in the range from about 50 micrograms (μg) to about 400 milligrams (mg), including all values and sub-ranges therebetween. In still another embodiment, the mass of powder delivered or dispensed is in the range from about 100 micrograms (μg) to about 5 milligrams (mg), including all values and sub-ranges therebetween. In modified embodiments, the mass of powder delivered or dispensed may be larger or smaller with efficacy, as needed or desired.

Embodiments of the invention can be efficaciously utilized to sample and deliver powders comprising a wide range of sizes and size distributions. In one embodiment, the powder comprises particle having sizes, diameters or effective diameters in the range from about 1 micron (μm) to about 1,000 microns (μm), including all values and sub-ranges therebetween. In another embodiment, the powder comprises particle having sizes, diameters or effective diameters in the range from about 5 microns (μm) to about 500 microns (μm), including all values and sub-ranges therebetween. In yet another embodiment, the powder comprises particle having sizes, diameters or effective diameters in the range from about 10 microns (μm) to about 300 microns (μm), including all values and sub-ranges therebetween. In still another embodiment, the powder comprises particle having sizes, diameters or effective diameters in the range from about 50 microns (μm) to about 200 microns (μm), including all values and sub-ranges therebetween. In a further embodiment, the powder comprises particle having sizes, diameters or effective diameters in the range from about 100 microns (μm) to about 150 microns (μm), including all values and sub-ranges therebetween. In modified embodiments, the powder may comprise particle having larger or smaller sizes, diameters or effective diameters with efficacy, as needed or desired.

One advantage of systems, apparatuses or devices in accordance with embodiments of the invention is that they can effectively and accurately operate substantially independently of the powder bulk or tap density. Without being bound to any particular definition, one definition of bulk or tap powder density is the density obtained from filling a container with the sample material and vibrating it to obtain near optimum packing—tap density is not an inherent property of a material but depends on particle size distribution, measurement techniques and/or interparticle voids.

In one embodiment, the powder bulk or tap density is in the range from about 0.03 to about 4 including all values and sub-ranges therebetween. In modified embodiments, the powder bulk or tap density may be larger or smaller with efficacy, as needed or desired. The powder packing may also be generally defined in terms of void fraction.

Some embodiments relate to powder sampling and dispense techniques in combination with liquid aspirate and/or dispense functions. Advantageously, this versatility allows for a broad range of applications which involve the handling and manipulation of solids and liquids (e.g., chemical and biological reagents).

U.S. Patent Application Publication No. US 2004/0146434 A1 discloses certain systems and methods of manipulating small amounts of solids. The entirety of this patent document is hereby incorporated by reference herein and is considered a part of the present patent specification/application.

U.S. patent application Ser. No. 12/020,438, filed Jan. 25, 2008, entitled NON-CONTACT POSITIVE DISPENSE SOLID POWDER SAMPLING APPARATUS AND METHOD, Attorney Docket No. ENTEV.001A, discloses certain embodiments of powder handling or manipulation. The entirety of this patent document is hereby incorporated by reference herein and is considered a part of the present patent specification/application.

In some embodiments, to dispense liquid or reagent drops down to the nanoliter, and in some cases in the picoliter, range a technology and product base as available from BioDot, Inc. of Irvine, Calif., U.S.A. is utilized to deliver liquids or reagents. In brief, the BioDot dispensing (and/or aspirating) system in accordance with some embodiments, comprises a positive displacement syringe pump or device (or a direct current fluid source) hydraulically coupled or in fluid communication with a solenoid dispenser or actuator, and motion control means or device(s) to provide relative motion between the dispensing/aspirating tip and the target(s)/source(s), as needed or desired. BioDot's U.S. Pat. Nos. 5,738,728, 5,741,554, 5,743,960, 5,916,524, 6,537,505 B1, 6,576,295 B2, RE38,281 E, U.S. Patent Application Publication Nos. US 2003/0211620 A1, US 2004/0072364 A1, US 2004/0072365 A1, US 2004/0219688 A1, US 2005/0056713 A1, US 2006/0211132 A1, and European Patent No. EP 1 485 204 B1, the entirety of each one of which is hereby incorporated by reference herein, disclose liquid dispensing (and/or aspirating) systems and methods which can be efficaciously utilized in accordance with certain embodiments of the invention. All of these patent documents comprise a part of the present patent specification/application.

U.S. Pat. Nos. 6,063,339, 6,551,557 B1, 6,589,791 B1, and U.S. Patent Application Publication Nos. US 2002/0064482 A1, US 2003/0207464 A1, US 2003/0215957 A1, US 2003/0228241 A1, the entirety of each one of which is hereby incorporated by reference herein, disclose liquid dispensing (and/or aspirating) systems and methods which can be efficaciously utilized in accordance with certain embodiments of the invention. All of these patent documents comprise a part of the present patent specification/application.

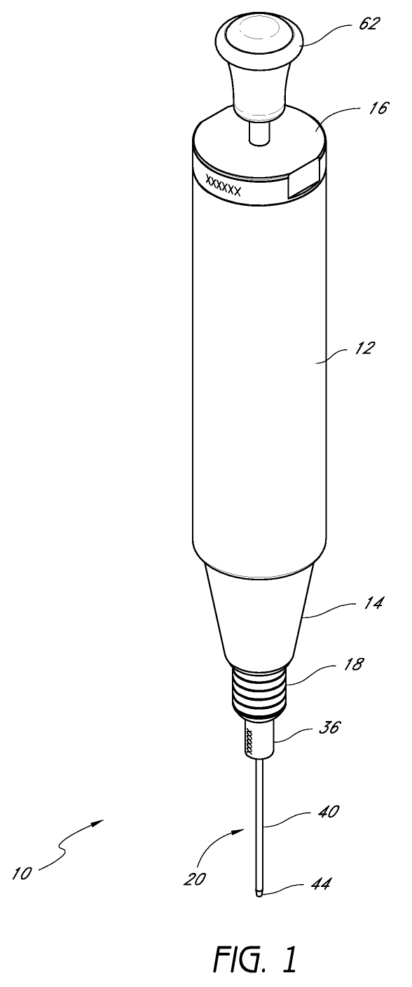

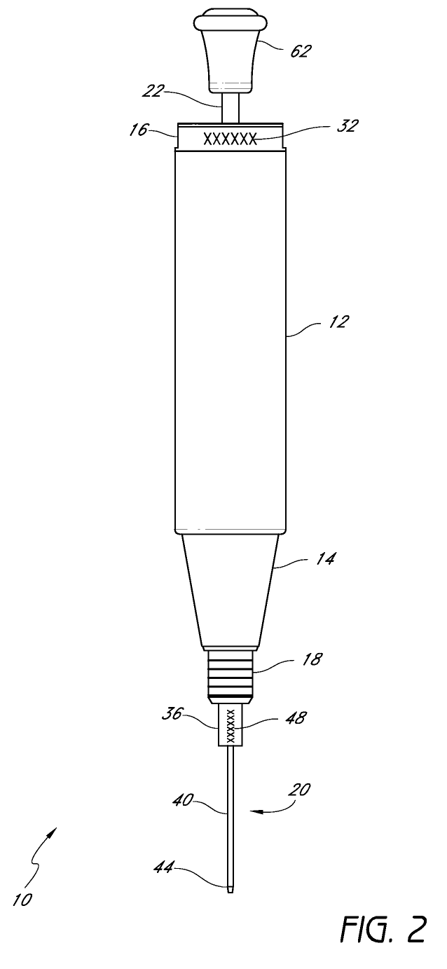

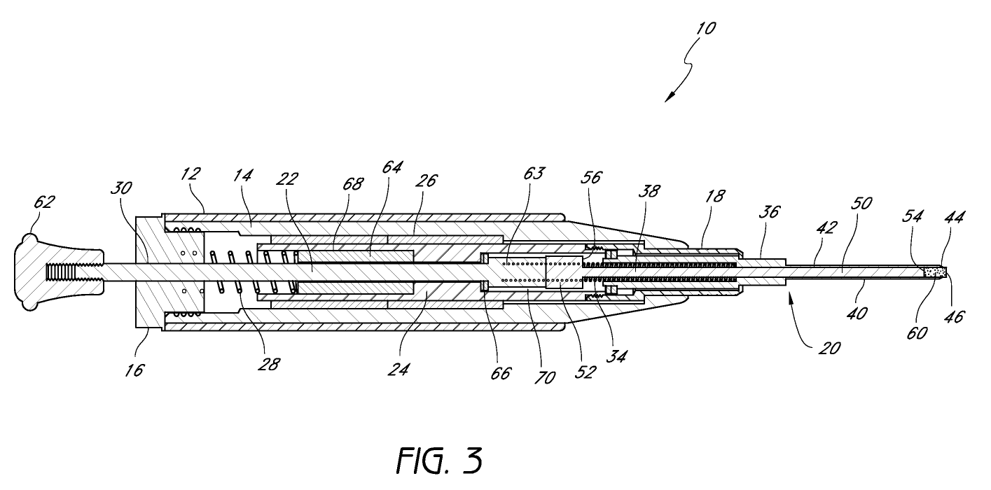

Turning now to the drawings, FIGS. 1-3 show different views of certain embodiments of a handheld powder handling or manipulating device, apparatus or system 10. The handheld powder handling device 10 is capable of reliably sampling or aspirating a predetermined amount of powder from a source and dispensing or delivering the powder to a target site.

The handheld powder handling device 10 generally comprises a grip 12, an outer housing or barrel 14, a cap 16 at a proximal end or portion of the outer housing 14, a probe housing 18 at a distal end or portion of the outer housing 14, a probe 20 mounted to the probe housing 18, an ejection or plunger rod or mechanism 22, and an inner housing or insert 24.

The grip 12 is generally cylindrical in shape and circumscribes at least a portion of the outer housing 14. The grip 12 is desirably ergonomically shaped and/or contoured to be held by a hand of a user. The grip 12 may comprise a textured surface, a ribbed surface, a stubbed surface, a surface with pillars, or the like, so as to advantageously facilitate a reliable grip to hold the powder handling device 10 by a user.

In some cases, the grip 12 can have ergonomic design analogous to a liquid pipettor or pipette. The grip 12 can be fabricated from a number of suitable materials, for example, but not limited to a soft foam, a plastic or other compliant grip material, as needed or desired.

The outer housing 14 is generally hollow and cylindrical in shape and may have an outer taper at its distal portion. Several of the components of the handheld powder sampling device 10 reside within the outer housing 14.

As discussed in further detail below, the outer housing 14 is moveable or displaceable in a generally axial direction and is used in the powder sampling or aspirating process. To control and facilitate this motion, the outer housing is operatively coupled to one or more bearings 26 (e.g., linear bearings) or the like, and a source of energy storage and release such as a probe compression spring 28.

The cap 16 has a generally cylindrical configuration and is partially received within the proximal end or portion of outer housing 14. The cap 16 closes the proximal end of the outer housing 14 and is mechanically or magnetically attached or connected thereto. This connection may be a substantially sealing connection, at least to some extent. The cap 16 has a generally central through opening 30 that receives at least a portion of the ejection rod 22. The cap 16 is also connected to a proximal end or portion of the compression spring 28, thereby coupling the outer housing 14 thereto.

In some embodiments, and as discussed further below, the cap 16 is color coded and marked with a serial number 32 or the like. This provides a user-friendly identification system when a series of powder handling devices, with each specifically designed for delivery of a particular amount (mass and/or volume) of a powder, are employed.

The probe housing 18 has a generally cylindrical configuration and is partially received within the distal end or portion of outer housing 14. The probe housing 18 has a generally central through opening that receives a portion of the probe 20 and within which the probe 20 is mechanically or magnetically connected or attached to a proximal end or portion of the probe housing 18. As discussed further below, the probe housing 18 also receives a portion of a source of energy storage and release, such as a probe plunger spring 34. In some embodiments, the probe housing 18 can connect to a range of probe sizes.

The probe 20 generally comprises a probe body 36 and a generally axially moveable or displaceable probe plunger 38 that is used to deliver or dispense the desired mass of sampled powder, as discussed in further detail below. A portion of the probe body 36 is received within the probe housing 18, and a distal end or portion of the probe body 36 is mechanically or magnetically connected or attached to a proximal end or portion of the probe housing 18. A portion of the probe plunger 38 also extends within the probe housing 18.

The probe body 36 has a generally cylindrical configuration, desirably of varying diameters, with an axial opening extending therethrough. The probe body 36 generally comprises a distal generally cylindrical tip 40 with a generally cylindrical inner passage or lumen 42 and a distal end 44 with an opening or orifice 46. The distal end 44 may have a beveled, conical or inwardly tapered outer configuration to facilitate insertion into a powder source, and a protective cap or the like can be provided to cover the orifice 46 when the device is not in use. The exposed portion of the probe body can be marked with a serial number 48 or the like for probe identification purposes.

The probe plunger 38 has an elongated and generally cylindrical configuration. The probe plunger 38 generally comprises a telescoping rod or barrel 50 and a proximal barrel/stop portion 52 with a larger outer diameter or periphery. The telescoping rod or barrel 50 has a distal end 54 and the stop portion 52 has a distal face or end 56.

The plunger rod or barrel 50 is received within the probe body 36 and extends into the probe tip 40. The tip lumen space between the rod distal end 54 and the tip distal end 44 and/or tip orifice 46 generally defines the fill space or volume 60 of the powder to be sampled and dispensed. (Various arrangements and parameters of this volume and its adjustability are discussed further herein.) A proximal portion of the rod 50 can also extend into the outer housing 24, typically when the probe plunger 38 is not in an actuated state or dispense mode.

The probe plunger spring 34 extends over a portion of the plunger rod or barrel 50 and through the plunger stop 52. As discussed in further detail below, the spring 34 is also connected to a distal portion of the ejection rod 22, and serves to bias the probe plunger 38 to its operational state after a powder delivery or dispense operation.

The ejection rod 22 has a generally cylindrical configuration with a proximal end or portion mechanically or magnetically connected or attached to a push button, knob or cap 62 or the like. The bush button B62 is configured to be depressed or actuated (e.g., by a thumb of a user) in a generally axial direction to actuate ejection of the powder. The push button 62 comprises the proximal-most portion of the device 10 and serves to actuate or push the ejection rod 22 during a powder delivery or dispense operation. The push button 62 can be fabricated from a number of suitably durable and lightweight materials, such as, but not limited to, a plastic, a metal (e.g., aluminum), an alloy, (e.g., different kinds of steels), among others, as needed or desired.

The ejection rod 22 is of an elongated configuration and has a distal pusher portion or barrel 63 of a larger diameter or periphery. A distal end or face of the pusher portion 63 is mechanically or magnetically connected or attached to (or contacts or abuts) a proximal face or end of the probe plunger stop portion 52.

As discussed in further detail below, the ejection rod 22 is moveable or displaceable in a generally axial direction and is used in the powder delivery or dispensing process. To facilitate this motion, the outer housing is operatively coupled to one or more bearings 64 (e.g., a linear bearing) or the like. A portion of the probe compression spring 28 extends over a portion of the ejection rod 22 and a distal end of the spring 28 abuts (or is connected to) a proximal end the bearing 64.

In some embodiments, and as discussed further herein, one or more variable thickness spacers 66 are mechanically or magnetically connected to the proximal face of the ejection rod distal pusher portion 63 and abut an opposed face of the inner housing 24. The spacers 66 serve to generally define the fill volume 60 (and, as such, the subject powder mass) and allow for adjustability of the same, thereby advantageously providing overall versatility and adaptability.

The ejection rod 22 extends from the push button 62, through the cap 16 into the outer housing 14, and then into the inner housing 24. The bearing 64 is coupled to a portion of the ejection rod 22 within the outer housing 24. The ejector rod pusher portion 63 is the distal-most portion of the ejector rod 22 and is spaced from the bearing 64 by a reduced inner diameter portion of the inner housing 24.

The inner housing or insert 24 couples to several components of the handheld device 10. The inner housing 24 has a hollow generally cylindrical configuration with a generally cylindrical inner passage 68, desirably of a variable diameter or periphery. The one or more linear bearings 26 associated with the outer housing 14 engage an inner surface of the outer housing 14 and an outer surface of the inner housing 24.

The inner passage 68 of the inner housing 24 has a proximal portion, a distal portion 70 and a medial portion therebetween having a reduced diameter or periphery. The proximal portion of the inner passage 68 receives at least a portion of the probe compression spring 28, a portion (smaller diameter) of the ejection rod 22, and the one or more linear bearings 64 associated with the ejection rod 22. The medial portion of the inner passage 68 also receives the smaller diameter portion of the ejection rod 22.

The distal portion 70 of the inner passage 68 receives a portion of the ejection rod 22 including the pusher portion 63 and the associated one or more spacers 66. The distal portion 70 of the inner passage 68 receives a portion of the probe plunger 38 including the pusher portion 63 and a portion of the probe plunger spring 34.

The force applied to eject the powder can be varied, for example, by appropriate selection the probe plunger spring 34. In some cases, this fore will be analogous to a liquid pipettor. The spring constant is typically about 2.0 to 2.5 lb/inch, but it can range from about 1 lb/inch or less to about 5 lb/inch or more.

The compression travel of the outer housing or barrel 14 can be appropriately selected as well as the properties of the associated probe compression spring 28. For example, the probe compression travel can be about 12 mm. This may be divided in increments, for example, equally divided increments of about 2 mm for in-process powder compression or compaction. This is advantageous in some cases, and typically allows for the powder to be compressed by up to about 20% or more, depending on the powder properties. This would also vary the hardness of the powder plug. Additionally, the compression can be useful for delivering a different mass (an increase of about up to 20% or more) for a given volume due to increased compression. Another compaction advantage can be that it would provide some control over the height-diameter ratio of a sampled powder plug. The probe compression spring constant is typically about 9 to 10 lb/inch, but it can range from about 5 lb/inch or less to about 20 lb/inch or more. Another advantage of the probe compression spring 28 is that it for overdrive protection/compensation to the moveable outer housing 14.

Thus, in some embodiments, for a fixed height or fill volume 60 the targeted powder mass can be sampled substantially independently of the fill height. This advantageously provides enhanced versatility and adaptability in operation. The compression force (pressure) can be measured by a suitable sensor or transducer, such as a load cell arrangement. Correlations can be created (e.g., by regression analysis or the like) to relate the compression force and sampled mass for different powders.

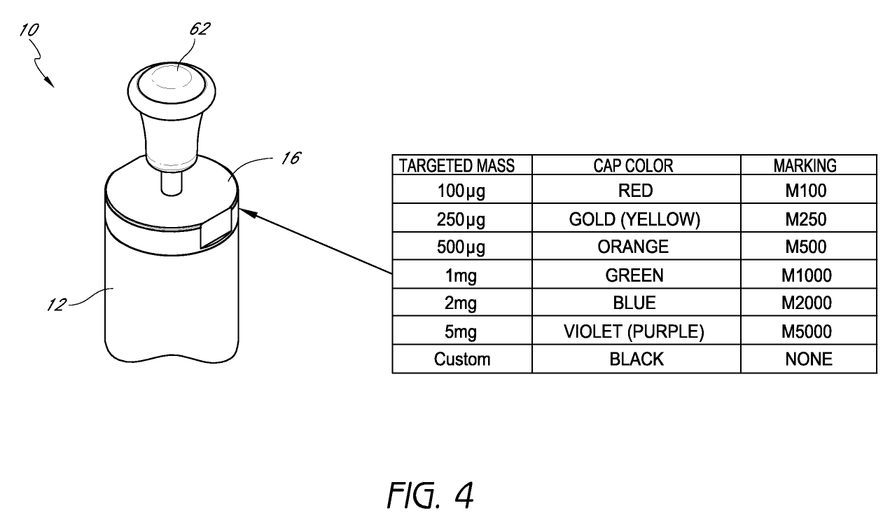

Referring now to FIG. 4, in some embodiments, the cap 16 is color coded and marked. Advantageously, the colorization provides immediate visual identification of the probe mass for a particular handheld device. The product labeling or marking also facilitates in easy identification of probe mass. The table in FIG. 4 illustrates these features for several example targeted masses.

The size of the probes 20 used in conjunction with any of the handheld powder handling embodiments disclosed herein can be selected, as needed or desired. For example, a single probe size may be used or a field-selection of sizes. The probe size can be characterized by the inner diameter of the probe tip 40 (or the diameter of the lumen 42). Typical probe sizes can include, without limitation, 0.5, 0.8, 1.0, 2.0, 3.0 and 5.0 mm diameters, among others. In some embodiments, an interchangeable assembly allows all probes to be used with a single handheld device. This also provides for easy repair and replacement of a probe. The device configuration, in some cases, requires no special tools for setup, repair, and switching of probes.

The handheld device in accordance with embodiments of the invention can allow for fixed sampling quantity (mass, volume) configurations. These include, without limitation, 100 μg, 250 μg, 500 μg, 1 mg, 2 mg, 5 mg, 10 mg, 25 mg, among others. The variable thickness spacers 66 powder fill height adjustment. For example, this can be in fixed intervals of 0.1 mm to 0.5 mm for combinations of fill heights to yield target mass. (combination of spacers to yield a total desired fill height). Robust device design for setting of fill height so that variations in fill height setting are minimized.

The following table illustrates some examples of probe parameters:

| | | Probe | |
|---|---|---|---|
| DisPo ™ | | Diameter | Fill height - |
| Model | Mass | (mm) | Spacers (mm) |
| M100 | 100 μg | 0.5 | 0.4 - 0.2 × 2 |
| M250 | 250 μg | 0.8 | 0.2 |
| M500 | 500 μg | 1.0 | 0.6 - 0.5 + 0.1 |
| M1000 | 1 mg | 2.0 | 0.5 |
| M2000 | 2 mg | 2.0 | 0.8 - 0.5 + 0.2 + 0.1 |
| M5000 | 5 mg | 3.0 | 0.1 |
| M10k | 10 mg | 5.0 | — |
| M25k | 25 mg | 5.0 | — |

The handheld powder handling devices disclosed herein, such as the device 10, can be efficaciously fabricated from a number of materials. In one embodiment, many of the device components are fabricated from aluminum for combined durability and weight balance. In certain embodiments, some components may be magnetically connected to provide for easy assembly, disassembly and interchangeability. In some embodiments, the handheld devices may be serviceable by the user, for example, to replace springs, and in these cases ease in disassembly and assembly is desirable.

The handheld powder handling devices disclosed herein, such as the device 10, can sample powder from a wide range of sources. For example, but not limited to, tubes/vials 1.75 inches tall (4 mL scintillation vials) or vials 2 inches tall (20 mL scintillation vials), among others.

The dispensing performance of the handheld powder handling devices disclosed herein advantageously achieves an accuracy greater than 95% and has a % CV with 10 replicate samples of less than or equal to about 10% CV. The intra probe-to-probe dispensing performance (i.e. multiple probes of same nominal dimensions) is also equivalent to the above accuracy and % CV.

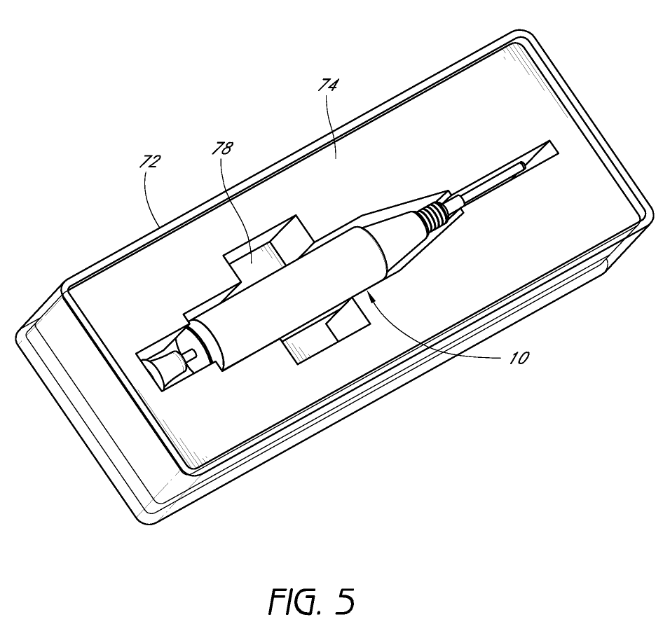

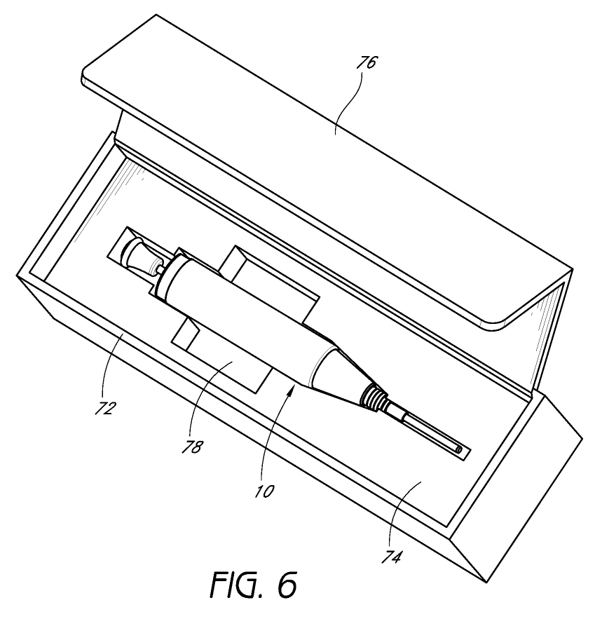

FIGS. 5 and 6 show some embodiments of a handheld device and probe(s) storage case and/or shipping box generally comprising a case 72, an insert 74 and a lid or cover 76 to allow for protection of the probes (s) and device when the device is shipped or when it is to be stored, for example, on a bench or in a drawer. The insert 74 can be designed to provide space 78 for additional sample probes of different sizes (target masses), as needed or desired. A decal and/or an instruction insert may also be provided to illustrate the device operation. The various components can comprise a handheld powder handling system or kit.

The case 72 and cover 76 are desirably formed from a hard plastic or the like, among others, to provide adequate protection. The insert 72 is custom designed and is desirably fabricated from foam or the like, among others, to provide a cushioning effect.

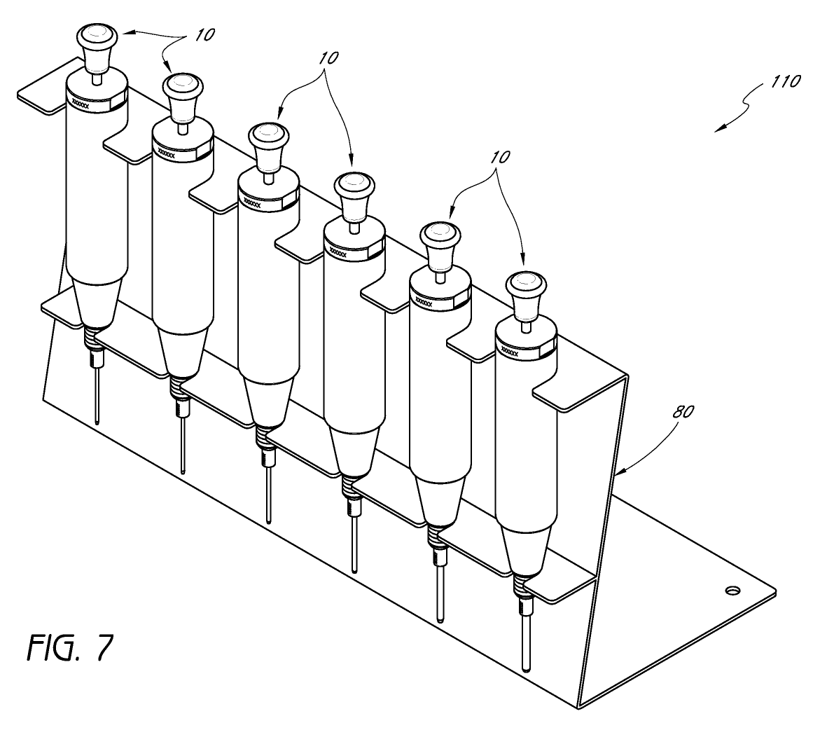

FIG. 7 shows some embodiments of a powder handling system or kit 110 comprising a plurality or array of handheld powder handling devices 10 mounted on a holder or rack 80. Each of the powder handling devices 10 has a respective probe of a different size (target mass). Desirably, the devices 10 have features designed in for rack mounting, such as on the outer surfaces of the devices 10.

The rack 80 can also be configured to hold individual probes 20 of different sizes or these can be mounted on a separate rack or holder to form part of the system or kit 110 or an independent system or kit. For example, one system or kit 110 can comprise two handheld devices 10 and one or more additional probes 20 of different sizes. Extra replacement and/or spare probes can also be included.

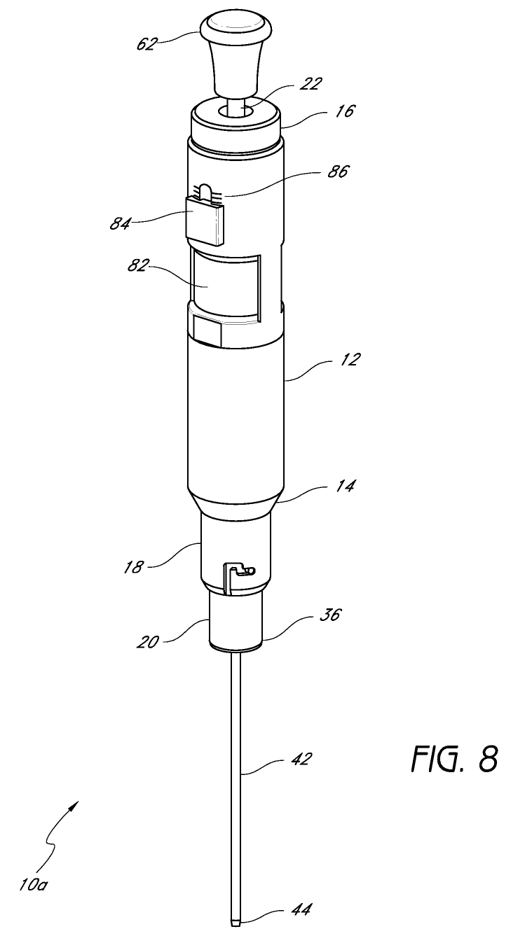

FIG. 8 shows certain embodiments of a handheld powder handling device 10a that is generally similar to the devices 10 but has a manually adjustable powder fill height or volume feature as opposed to internal variable thickness spacers. This can be thought of as having an on-board adjustable spacer mechanism.

The handheld powder handling device 10a comprises an adjustment thumb wheel 82 or the like and a position indicator 84 associated with indicia or markings 86 that reflect the powder fill volume 60 (or target powder mass) within the probe tip 42. The thumb wheel is operatively coupled to the probe plunger 38 and is capable of retracting or advancing it within the probe tip 44 to select a predetermined fill volume 60 (or target powder mass).

In some embodiments, the handheld powder handling device 10a comprises a removable probe 20. The probe 20 can be reusable or disposable. In some embodiments, only the tip portion of the probes 20 is disposable. A combination of reusable and disposable probes/tips of varying sizes may also be provided with efficacy. Any of these probes, and others taught herein (e.g., probes directed to a particular target amount or mass), can be efficaciously utilized in conjunction with any of the powder handling device embodiments disclosed herein, as needed or desired.

In the illustrated embodiment, the removable probe 20 is mechanically connected to the probe housing 36 using a quarter turn locking feature. In other embodiments, the probe 20 may be connected to the housing 36 in other mechanical or non-mechanical manners, for example, via a magnetic connection or the like.

In some embodiments, the device 10a can sample a powder mass based on a compression force (pressure) mode of operation as discussed above. Thus, for a fixed height or powder fill volume the targeted powder mass can be sampled substantially independently of the fill height. This advantageously provides enhanced versatility and adaptability in operation.

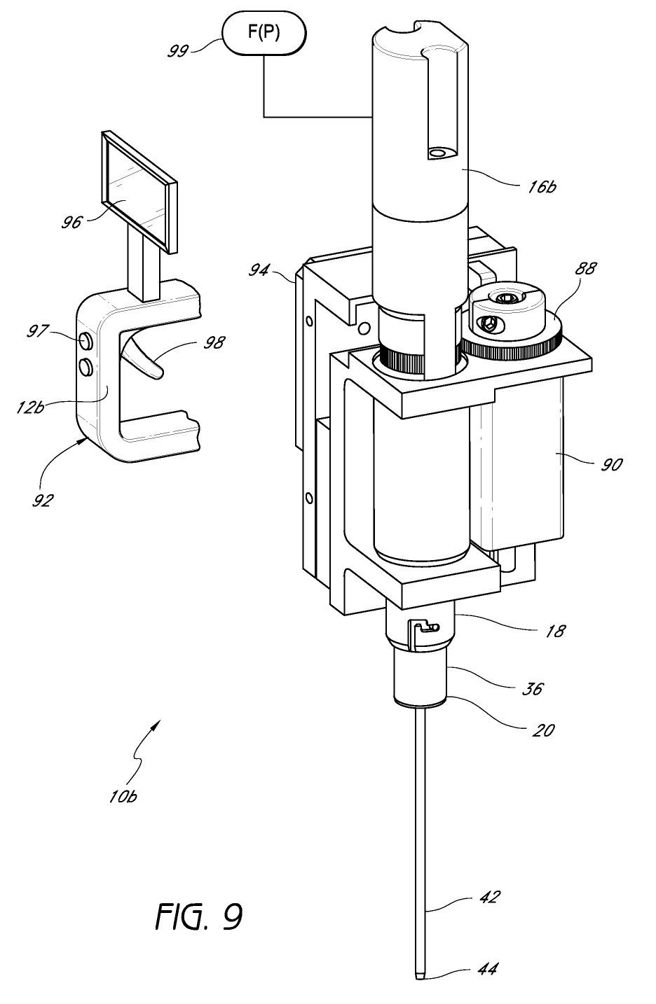

FIG. 9 shows certain embodiments of a programmable adjustable fill height (mass/volume) and pneumatically actuated (air operated) handheld powder handling device 10b. The handheld device 10b comprises a drive gearing 88 operatively coupled with an adjustment motor 90. The drive gearing 88 is operatively coupled to the probe plunger 38 and is capable of retracting or advancing it within the probe tip 44 to select a predetermined fill volume 60 (or target powder mass). In this manner a programmable adjustable powder fill height mechanism is provided.

The ejection mechanism 16b comprises a pneumatically actuated or air operated plunger to eject the target powder mass. This also allows the ability to operate in a predetermined substantially constant pressure (e.g., substantially powder height independent) mode.

In some embodiments, an ergonomically contoured handle 92 allows the user to hold the device 10b. The device operation may be controlled and monitored via a controller 94 or the like. The controller 94 can comprise an on-board unit or it may comprise an independent unit. A display or console 96 can be interfaced with the controller 94. The display 96 can be mounted to the device 10b or it may comprise a separate unit. For example, the display 96 may be connected to the handle 92 for ease in visualization.

Wireless coupling between control and monitoring elements may be efficaciously utilized, as needed or desired. Remote control devices can also be used with efficacy, as needed or desired.

The handle 92 can comprise one or more buttons 97 or triggers 98 interfaced with the controller so that the user can easily operate the device 10b while holding it. Optionally, control buttons and triggers can be independent from the device 10.

In some embodiments, one or more force or pressure sensors or transducers 99 are provided. For example, one sensor can comprise a force sensor to measure the compression force exerted on the powder during sampling, and another sensor can comprise a pressure sensor to monitor the pneumatic actuation pressure. The force or pressure sensors 99 are also desirably interfaced with the controller 94. In some embodiments, the sensor(s) comprise a load cell arrangement.

In some embodiments, the handheld powder handling device 10b comprises a removable probe 20, as discussed above. Also, as discussed above, any of the probe embodiments disclosed herein may be utilized in conjunction with the device 10b with efficacy, as needed or desired.

In some embodiments, the device 10b can sample a powder mass based on a compression force (pressure) mode of operation as discussed above. Thus, for a fixed height or powder fill volume the targeted powder mass can be sampled substantially independently of the fill height. This advantageously provides enhanced versatility and adaptability in operation.

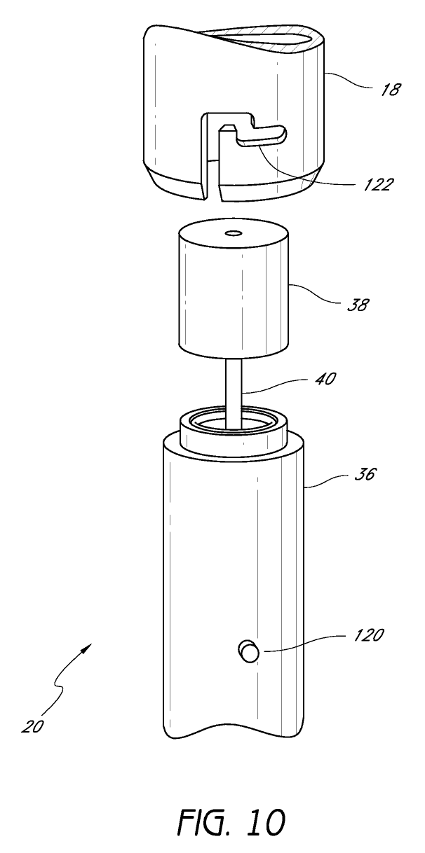

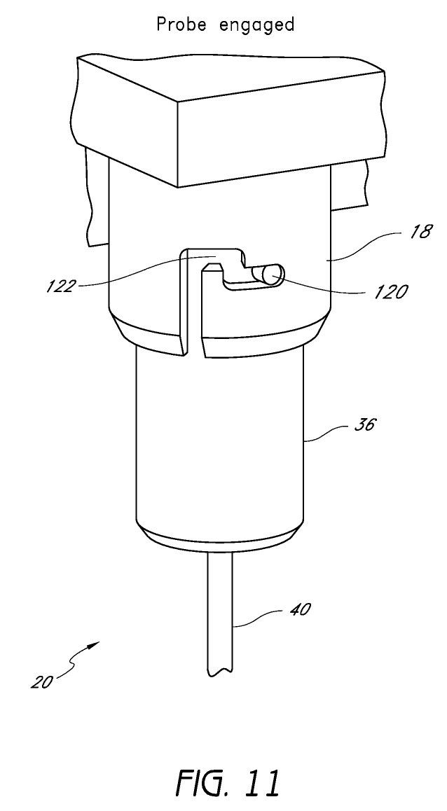

FIGS. 10 and 11 show certain embodiments of the interfacing between the removable probe 20 with the probe housing 18. In some embodiments, the probe body 36 comprises a locating boss 120 or the like that engages a locking feature 122 of the probe housing 18. For example, a substantially quarter turn coupling mechanism can be utilized with efficacy, among others, such as a collet-type of interface.

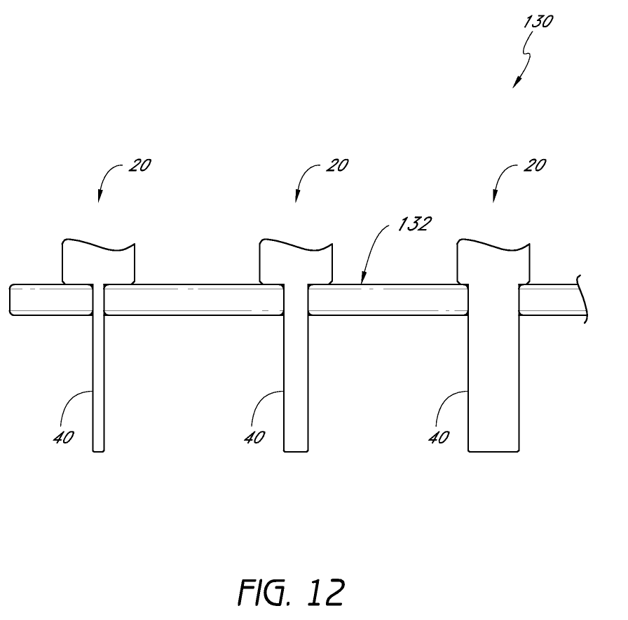

FIG. 12 shows some embodiments of a powder handling probe system or kit 130 comprising a plurality or array of probes 20 mounted on a holder or a rack 132. Each of the probes 20 can comprise a different size (target mass) probe. Desirably, the probes 20 have features designed in for rack mounting, such as on the outer surfaces of the probes 20.

The probes 20 can comprise removable probes that are reusable or disposable. Similarly, probe tips 40 with different sizes can be efficaciously mounted on a holder or rack, wherein the tips are reusable or disposable, as needed or desired.

### Some Powder Source Embodiments, Arrangements and Features

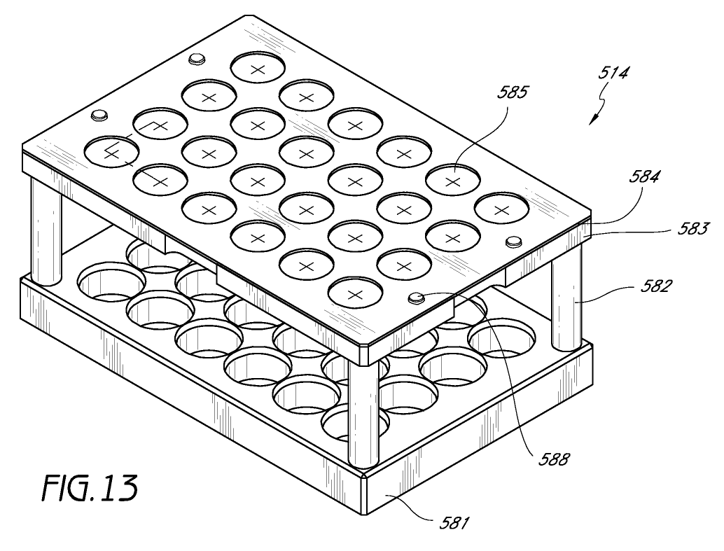

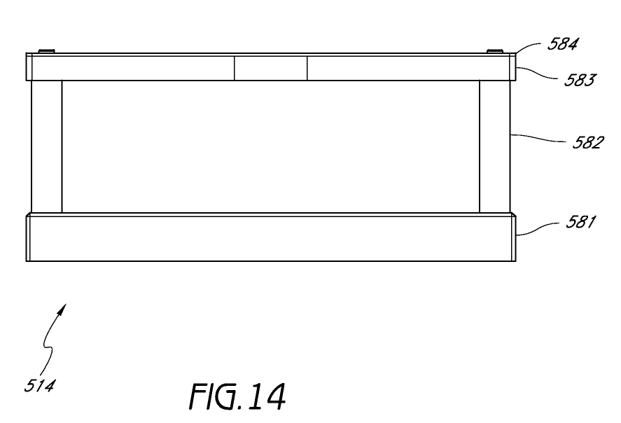

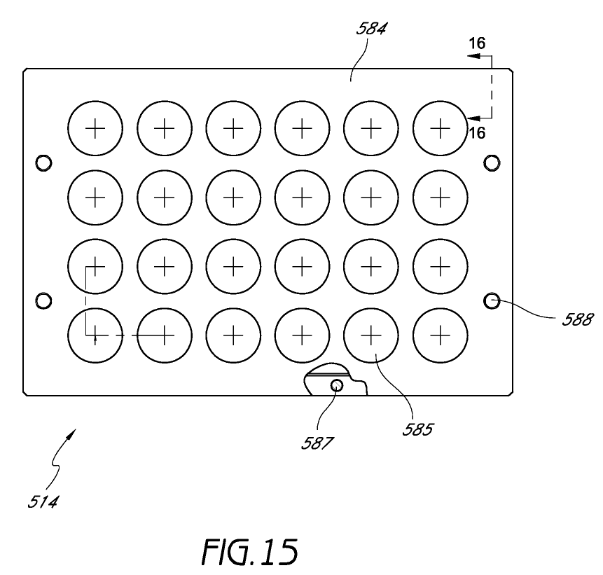

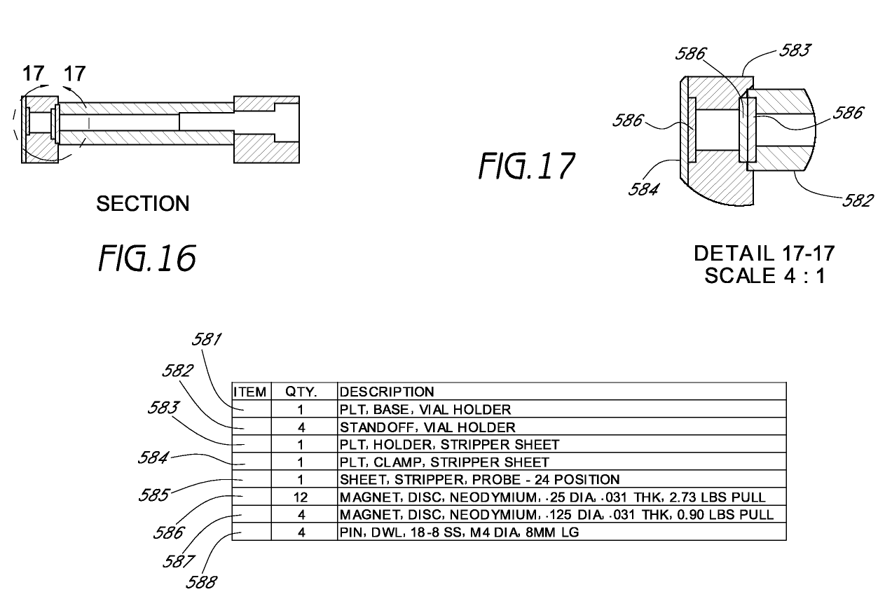

FIGS. 13-17 show different views of certain embodiments of a powder vial holder assembly 514. The vials are not shown in these figures, but they would occupy and be arranged in a (4×6) configuration in these embodiments.

FIG. 17 includes a chart that identifies the general description of components denoted by reference numerals 581, 582, 583, 584, 585, 586, 587, and 588. Advantageously, in accordance with certain embodiments, the design of the flexible stripper sheet 585 allows entry of the sampling probe to access the source powder and strips, scrapes or shears off any excess powder that may be adhered to the probe outer surface as the probe is retracted from the powder source vials.

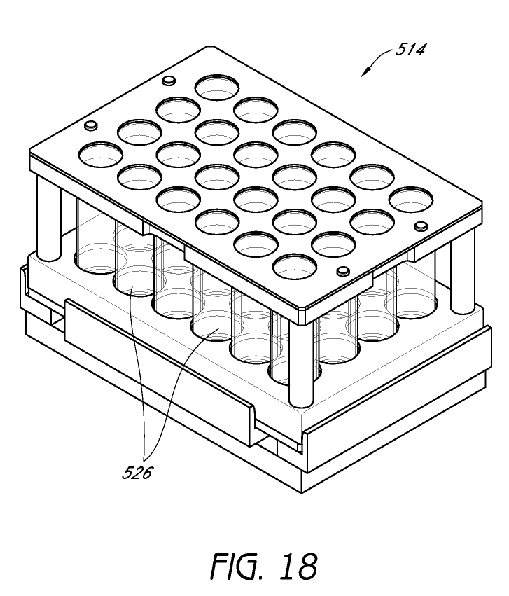

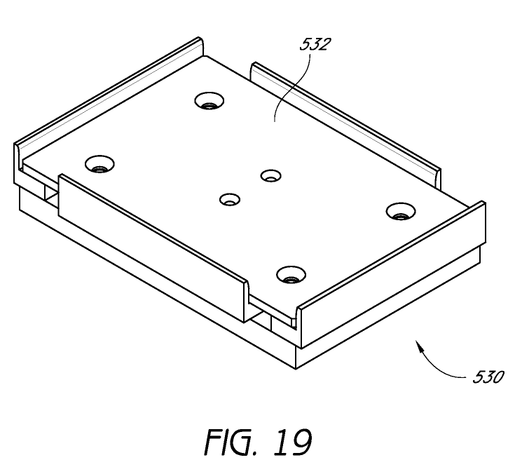

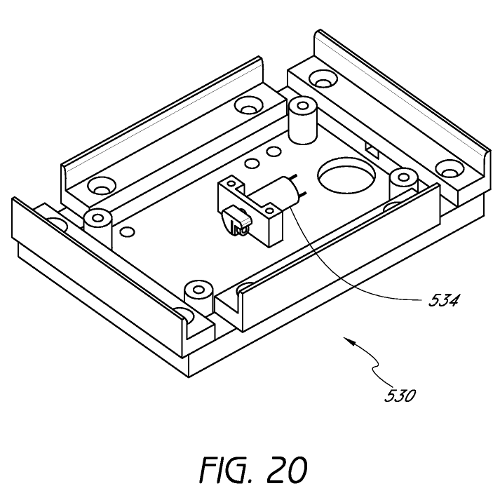

FIGS. 18-20 show various views of certain embodiments of a powder source or vial holder assembly 514 and some of its componentry. The vial holder assembly 514 shows a plurality of powder source vials 526, and in some embodiments, comprises a base structure 530 that includes a vibration plate 532 driven by a vibration motor 534 to provide controlled vibration and shaking to the powder containing vials 526, for example, to facilitate powder settling in the vial after a sampling operation. The vibration motor 534 can efficaciously be mounted on any suitable location of the vial holder assembly 514, such as at a lower, upper or intermediate position, as needed or desired.

It is to be understood that the flexible stripper sheet embodiments and the vibration plate embodiments of the powder source assemblies 514 can be efficaciously combined, as needed or desired.

### Some Powder Handling Methods and Processes

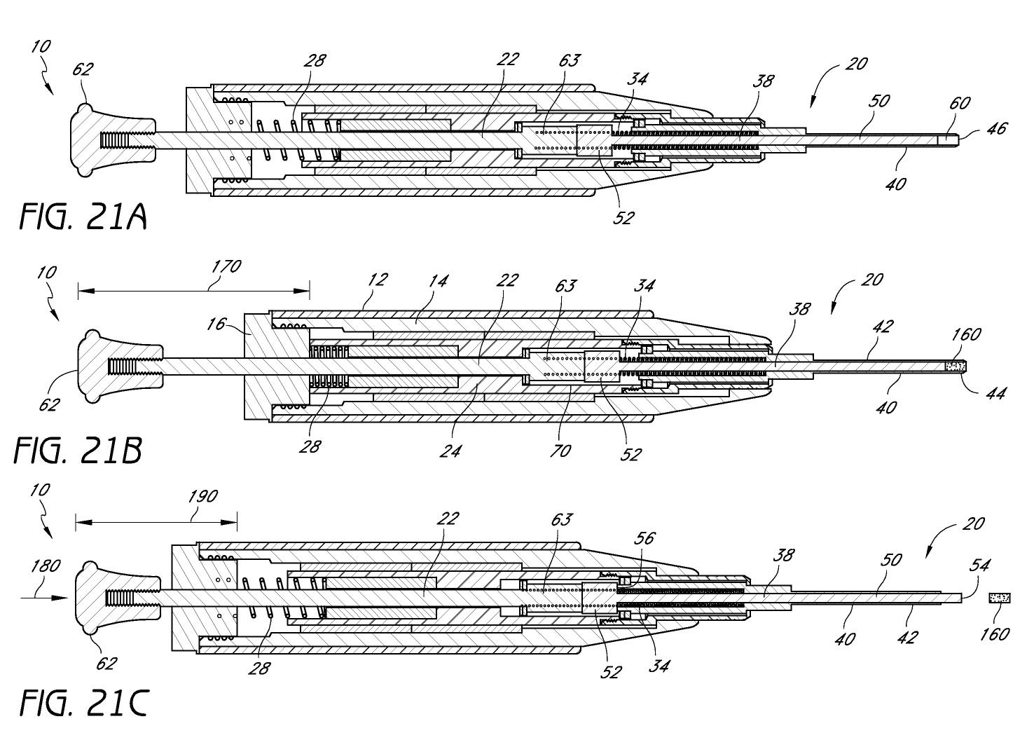

FIGS. 21A-21C, 22 and 23 show various views and formats of certain embodiments of a handheld powder sampling and dispensing method or process. Though some of these drawings refer to embodiments of the handheld device 10, it should be understood that the methods are substantially equivalently applicable to other handheld embodiments (e.g., devices 10a, 10b), possibly with minor adjustments. Thus, any of the powder sampling and dispensing systems taught or suggested herein may be utilized and/or configured to perform the step or acts of embodiments of this method or process.

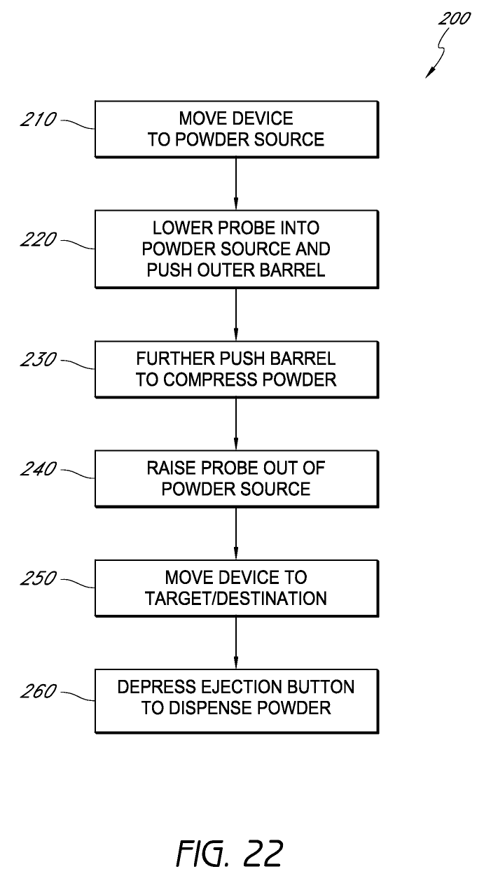

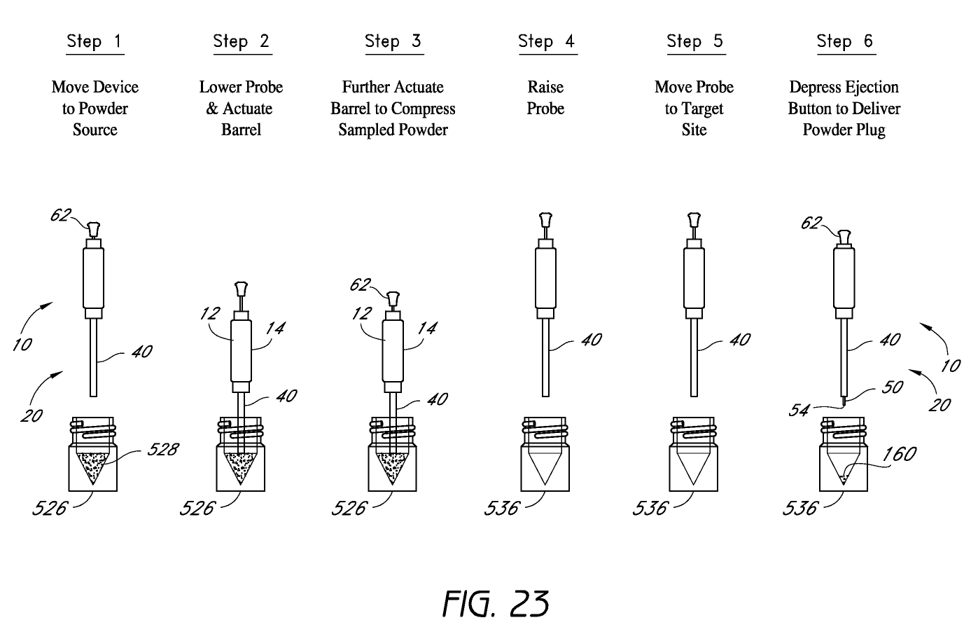

FIGS. 21A-21C are sectional views of the handheld powder handling device in various stages of operationally sampling and dispensing a powder. FIG. 22 is a simplified flowchart 200 of a powder handling process or method. FIG. 23 is a simplified overview of a powder handling process or method using the handheld device 10.

When the handheld device 10 is ready to sample it is in a state with a predetermined fill volume 60 available for powder sampling (see FIG. 21A). The handheld device 10 is manually moved, by holding the grip 12, to position the probe 20 and probe tip 40 over a powder source 526 containing a powder 528 to be delivered. This is generally depicted by step or act 200 in FIG. 22 and “Step 1” in FIG. 23. The setting of the fill volume 60 can also be accomplished while the probe 20 is over the powder source 526.

The sampling of powders can occur from many different source vessels, including microwell plates, scintillation vials, dram vials, tube-based storage systems, among others. Delivery can occur to the same formats as well.

The probe tip 40 is lowered into the powder source 526 and the device outer housing or barrel 14 is pushed in a generally axial direction towards the powder source 526 so that it slidingly moves forward. This is generally depicted in FIG. 21B, step or act 220 in FIG. 22, and “Step 2” in FIG. 23. The user holds the grip 12 by hand and with the distal end 44 of the probe tip 40 in or on the powder 528 pushes in a generally downwards direction so that the spring 28 is compressed and a predetermined amount (mass, volume) of powder 160 is extracted or enters into the fill volume 60.

The amount of displacement of the barrel 14 (compression of spring 28) or repetition of the barrel pushing process can be used to compact or compress the sampled powder 160, as needed or desired. This is generally depicted in step or act 230 in FIG. 22, and “Step 3” in FIG. 23. This can advantageously provide the ability to pick up powders at either constant displacement (e.g., known powder depth) or constant pressure (e.g., powder height independent), or a combination thereof. (The powder compression can desirably be used achieve a certain powder bulk density or void fraction.)

The downward force on the barrel 14 is relieved and the probe tip 40 is raised from the powder source 526 with the user holding the device 10 by the grip 12. The barrel 14 and spring 28 return to their original state, and a predetermined mass, volume, amount or quantity of the powder 160 has now been sampled and loaded into the probe tip 40 for delivery. This is generally depicted in step or act 240 in FIG. 22, and “Step 4” in FIG. 23. (The barrel motion is generally depicted by arrows 170 in FIG. 21B.)

The device 10 is moved to a target destination or vial 536 and the probe tip 40 is positioned over it with the user holding the device 10 by the grip 12. The target vial 536 is a location wherein or whereat the sampled powder is to be delivered or dispensed. This is generally depicted in step or act 250 in FIG. 22, and “Step 5” in FIG. 23.

The user actuates the ejection mechanism or depresses the ejection button 62 in a direction 180 (e.g., by using a thumb) to eject or dispense a predetermined quantity (mass, volume) of the powder 160 into the target vial 536. This is generally depicted in FIG. 21C, step or act 260 in FIG. 22, and “Step 6” in FIG. 23. In some embodiments, the powder delivery or dispense comprises a non-contact positive dispense operation.

Depression of the ejection button 62 causes motion of the ejection rod or plunger 22 and probe plunger 38 in the general direction 180, and some compression of spring 34. More specifically, the ejection pusher or barrel 63 is displaced and pushes the probe plunger barrel or stop 52 so that the probe plunger telescoping rod or barrel 50 slideably and generally axially moves within the probe body lumen 42, and the rod distal end 54 ejects or dispenses a predetermined quantity of powder 160 (e.g., in the form of a plug). The contact or abutment of the rod distal end 56 between a distal end of probe housing 18 (or other device abutment surface) can serve as a stop to control the motion of the plunger rod 50.

Once the ejection button 62 is released, the ejection rod 22 and the probe plunger 38 and the spring 34 move back to their original state. The motion during these events is generally depicted by arrows 190.

Some embodiments relate to a handheld solid powder sampling and dispensing device The handheld device has an ergonomically contoured outer surface to be held by a user. Actuation of an outer member of the device causes a predetermined quantity of a powder to be loaded within the device. Actuation of a plunger mechanism causes the predetermined quantity of powder to be dispensed. The outer member and the plunger mechanism are independently operable. Advantageously, the target delivery quantity of powder can be varied by a device adjustment mechanism (and/or to some degree by a powder compaction process).

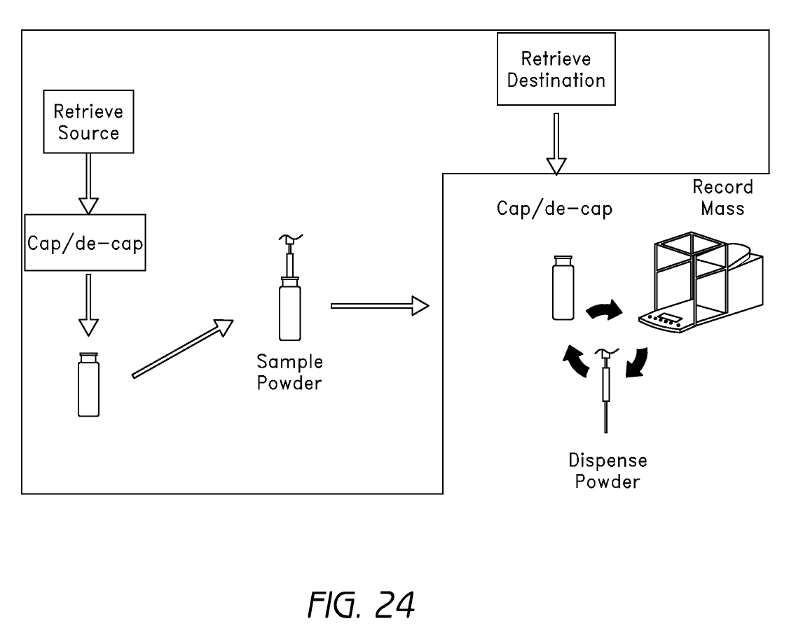

FIG. 24 shows an overview of certain embodiments of some operational steps for sampling or aspirating and delivering or dispensing powders. Any of the powder handling or manipulating devices, apparatuses, systems or kits taught or suggested herein may be utilized and/or configured to perform this process.

### Some Examples of Experimental Results

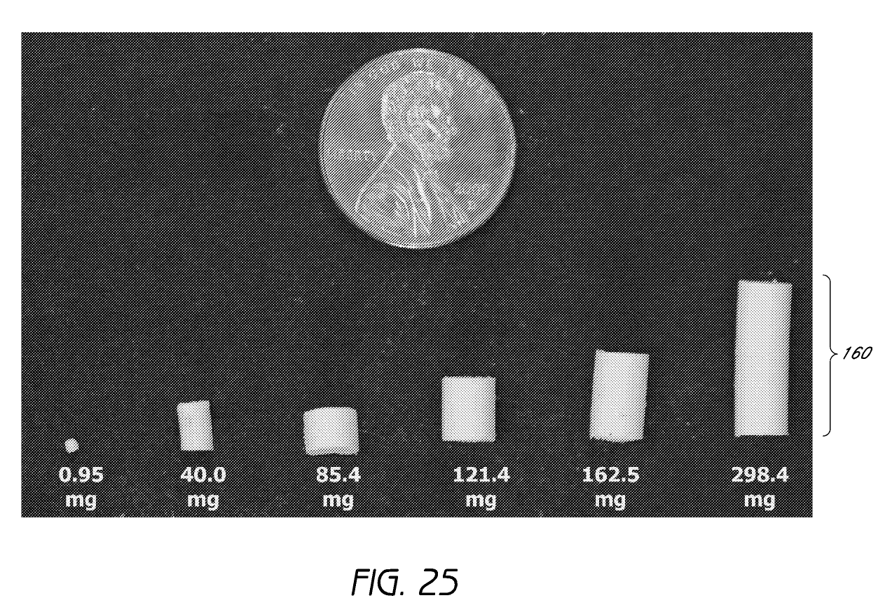

FIG. 25 shows exemplary embodiments of dispensed powder plugs of varying masses and height-diameter ratios. Any of the handheld powder handling devices, apparatuses, systems or kits taught or suggested herein may be utilized and/or configured to deliver these powder plugs with reliability and accuracy.

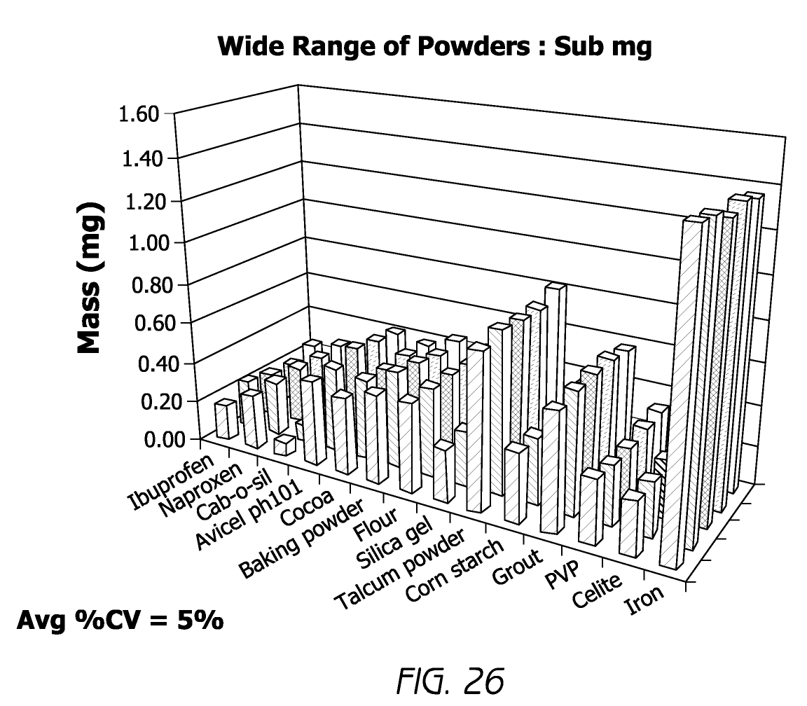

To further characterize embodiments of the handheld powder sampling and dispensing devices, a panel of number of different powders was dispensed in both the sub-microgram and microgram range. Each powder sample target mass was dispensed multiple times. The results of this panel of powders are depicted in FIGS. 26-29, and illustrate the accuracy and reliability achieved.

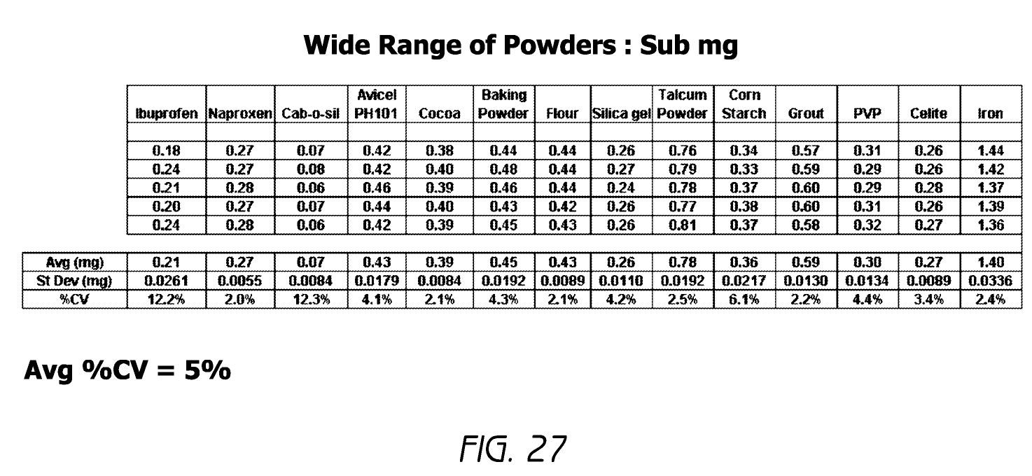

FIG. 26 is a graphical representation of replicated experimental results showing delivered powder mass (generally in the sub-milligram or microgram range) versus various different types of powder materials. FIG. 27 is a tabulated data chart corresponding to the powders dispensed in accordance with the graphical representation of FIG. 26 illustrating the high-level of accuracy achieved. The average percent coefficient of variation (% CV) is only about 5%, thereby highlighting the advantageous precision attained.

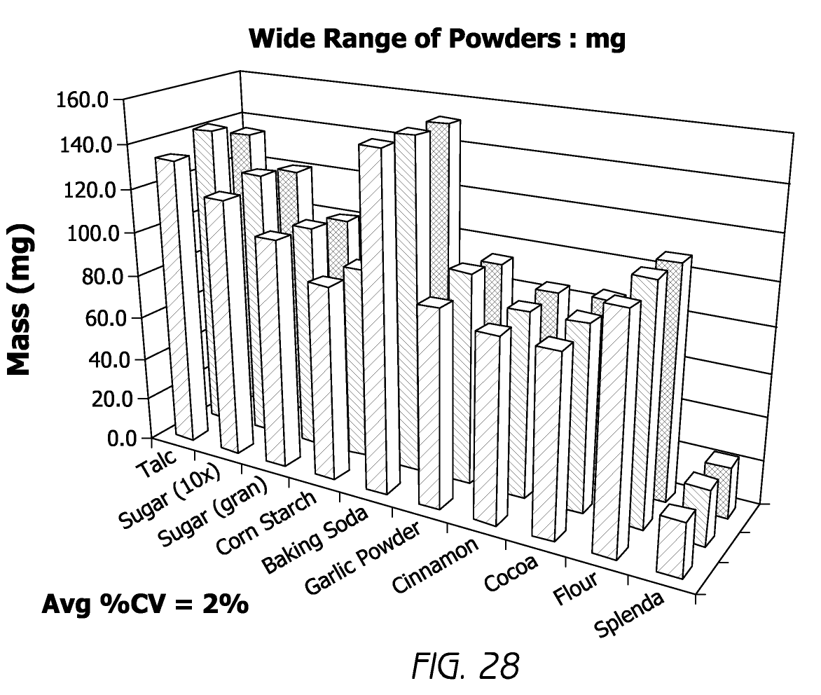

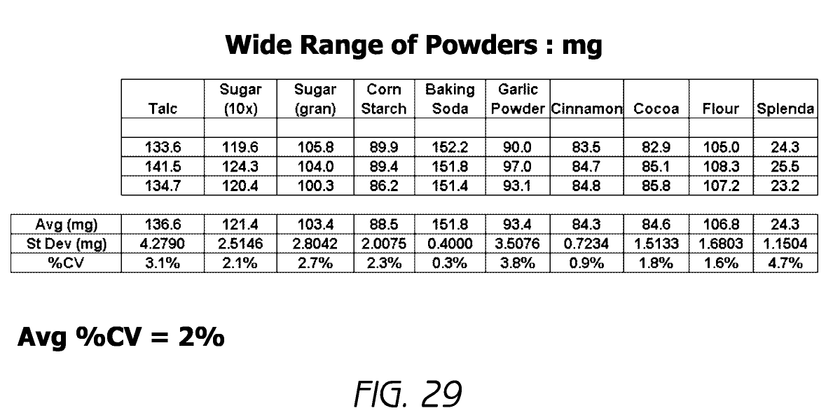

FIG. 28 is a graphical representation of replicated experimental results showing delivered powder mass (generally in the microgram range) versus various different types of powder materials. FIG. 29 is a tabulated data chart corresponding to the powders dispensed in accordance with the graphical representation of FIG. 28 illustrating the high-level of accuracy achieved. The average percent coefficient of variation (% CV) is only about 2%, thereby highlighting the advantageous precision attained.

It is important to note that the largest source of variability in dispensed mass, in some cases, is the variation in powder bulk density. The data in FIGS. 26-29, among other, signifies that advantageously a wide range of powder bulk densities can be accommodated with the powder sampling and dispensing embodiments as taught or suggested herein. While the absolute delivered mass of a powder at a fixed sample volume generally will vary with bulk density, it is desirably possible to adjust the target volume to deliver a specific mass. This can be achieved, for example, by a simple calibration with the powder of interest, or can be approximated if the bulk density (void fraction) of the powder is known.

### Some Examples of “Markets” Relating to Powder Handling and Manipulation

There continues to be an increase in demand for the discovery, development and optimization of new materials. These new materials cover the range from polymers, adhesives, and pharmaceuticals all the way to catalysts, phosphors and semiconductors. Through the advances championed by the pharmaceutical industry there now exists an automation infrastructure base that can support research in new materials at a basic level. In particular, many of the automation solutions developed for combinatorial chemistry and high throughput screening have been adapted to work with the broader array of reagents and compounds encountered in non-pharmaceutical applications. The combinatorial approach is ideally used in applications where interactions beyond simple 1 and 2 components are to be studied (e.g. ternary and quaternary mixtures). In many advanced materials discovery applications it is not uncommon to conduct experiments with 5 component mixtures (and greater). To the extent that these complex combinatorial experiments have been carried out in a micro-scale, with corresponding small material budgets, screening of conditions previously unthought-of have proven extremely valuable

However, many of the automated platforms tend to be expensive and may not necessarily address the concerns of many applications that would be more suited to a simplified and cost-effective approach. Moreover, many markets can benefit from an initial low-asset approach, before investigating the need for investing in a complex automated system.

Certain unique automation approaches are disclosed in U.S. patent application Ser. No. 12/020,438, filed Jan. 25, 2008, entitled NON-CONTACT POSITIVE DISPENSE SOLID POWDER SAMPLING APPARATUS AND METHOD, Attorney Docket No. ENTEV.001A, discloses certain embodiments of powder handling or manipulation. The entirety of this patent document is hereby incorporated by reference herein and is considered a part of the present patent specification/application.

Synthesis of New Materials: As advances in material property determination have been made, a renewed focus on creating materials and mixtures has begun. Depending on the nature of the material to be synthesized, a variety of techniques to create materials can be employed. Many of these approaches involve combinatorial methods, where complex multi-component mixtures are required in order to explore non-obvious “chemical space”. There have been advancements in liquid handling techniques, particularly inkjet-based approaches, resulting in the ability to explore synthesis approaches in the nanoliter to microliter regime. In addition to synthesis new materials themselves, there is a great deal of interest in changing the local environment (chemical, spatial, thermal, etc.) that a material exists in to explore and possibly exploit unique properties.

Optimization of Material Properties: Once a new material has been made it is often necessary or desirable to optimize its properties based on some measure of performance or critical property. There are many properties that are of interest, including mechanical, thermal, electrical, chemical, optical, morphological and magnetic. Based on measurement of the properties of interest, optimization of the material or its components occurs; iteration of syntheses and measurement continues until the final desired properties are achieved. Depending on the nature of the material these optimization experiments can involve either manipulating the material itself or its surrounding environment. Because many materials are costly to synthesize or produce, performing optimization experiments with minimal sample consumption is often desired. Optimization experiments in the nanoliter to microliter volume range and microgram to milligram mass range are quite common.

### Pharmaceutical Development

Polymorph Screening: A number of currently marketed pharmaceutical products have more than one crystalline form. A compound that exists in more than one crystalline form is considered to be polymorphic. While polymorphs are the same in terms of chemical composition, their physicochemical properties can very significantly. These differing physicochemical properties can dramatically affect a compounds efficacy due to changes in properties such as dissolution rate, solubility and bioavailability. Knowing this, pharmaceutical companies are moving toward more structured polymorph screens for new chemical entities. These screens are being performed earlier in the drug development process in order to maximize the chances that the most stable physical form is carried forward into the clinic. Regulatory bodies now also require demonstration of polymorph identification in submissions. Lastly, polymorph screening of compounds in late development is often valuable in terms of maximizing the intellectual property investment a pharmaceutical company has made, and offers opportunities to extend a patent portfolio.

Polymorph screening involves re-crystallizing a compound from a variety of organic solvents while often varying environmental conditions, such as rate of cooling, solution concentration (i.e. extent of supersaturation), rate of stirring (or absence of stirring), etc. Depending on the specific approach taken, and the amount of compound available for a screen, anywhere from 10's to 1000's of unique combinatorial conditions are created and analyzed for the resulting polymorphic form.

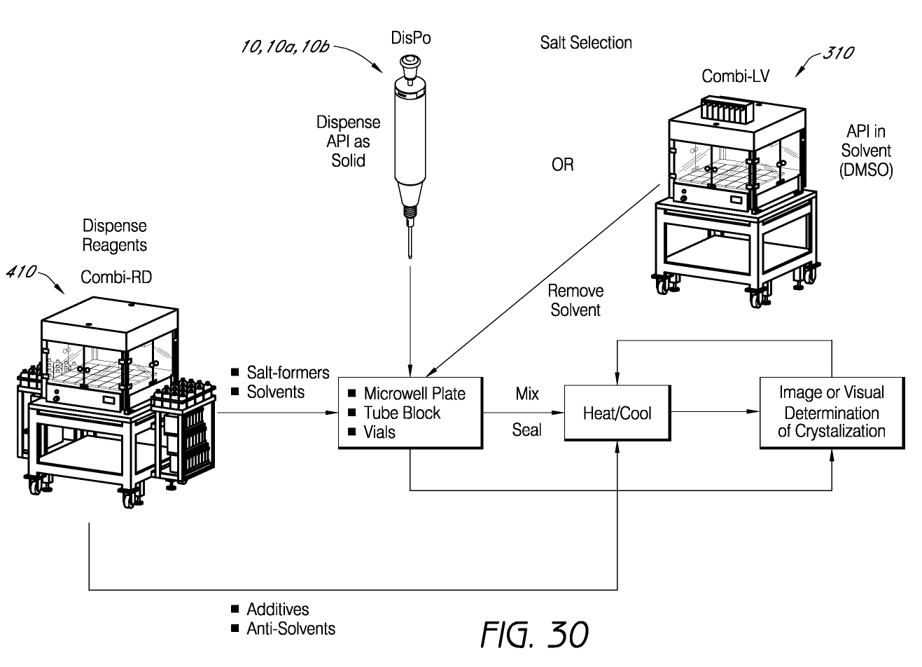

FIGS. 30-34 are respective schematic views of certain processes or methods involving: (i) salt selection; (ii) compatibility experiments; (iii, iv) solubility experiments; and (v) dosing studies having efficacy with certain embodiments of the invention. These figures illustrate the use of embodiments of various handheld powder handling devices and apparatuses 10, 10a, 10b (DiSPo™ Handheld Solid Dispensing System), a low volume liquid handling system 310 (Combi-RD-LV™ Reagent Dispenser), and a liquid handling system 410 (Combi-RD™ Reagent Dispenser). In some embodiments, but not limited to, the subject powder comprises of at least one active pharmaceutical ingredient or API.

Some embodiments of the system 410 are available from BioDot Inc. of Irvine, Calif., U.S.A. In some embodiments, the reagent dispenser 410 has been specially designed to work with the most challenging of reagents and fluids. Applications involving highly viscous reagents, dispensed in a non-contact combinatorial fashion, are readily served by the dispensing system 410. An example of this type of application would be pharmaceutical pre-formulation studies (some examples of which are discussed herein). The base system is configurable from a single syringe pump, up to as many as 96 individually controllable syringe pumps. The typical non-contact dispense volume range for the dispensing system 410, in some embodiments, is between about 2 microliters (EL) and about 5 milliliters (mL), depending on the specific properties of the reagents being dispensed (e.g., viscosity). The system 410 typically delivers these volumes to within 2% of the target volume with a reproducibility within 5% Relative Standard Deviation (RSD). There are optional heated fluid lines in order to extend the reagent dispensing range (e.g., decrease the effective reagent viscosity).

Some key benefits of the system 410 include, without limitation: ability to dispense a wide variety of fluids such as highly viscous fluids (viscosities up to ˜3000 cp), organic solvents, strong acids and bases; multi-channel configuration for combinatorial applications; flow-through dispense and aspirate/dispense modes (rheology dependent); and non-contact dispense mode for rapid dispensing with minimal carryover.

When dealing with lower liquid volumes, in some embodiments, to dispense liquid or reagent drops down to the nanoliter, and in some cases in the picoliter, range a technology and product base as available from BioDot, Inc. of Irvine, Calif., U.S.A. is utilized to deliver liquids or reagents. In brief, the BioDot dispensing (and/or aspirating) system in accordance with some embodiments, comprises a positive displacement syringe pump or device (or a direct current fluid source) hydraulically coupled or in fluid communication with a solenoid dispenser or actuator, and motion control means or device(s) to provide relative motion between the dispensing/aspirating tip and the target(s)/source(s), as needed or desired. In some embodiments, the low volume liquid handling system 310 comprises any one of these BioDot systems.

BioDot's U.S. Pat. Nos. 5,738,728, 5,741,554, 5,743,960, 5,916,524, 6,537,505 B1, 6,576,295 B2, RE38,281 E, U.S. Patent Application Publication Nos. US 2003/0211620 A1, US 2004/0072364 A1, US 2004/0072365 A1, US 2004/0219688 A1, US 2005/0056713 A1, US 2006/0211132 A1, and European Patent No. EP 1 485 204 B1, the entirety of each one of which is hereby incorporated by reference herein, disclose liquid dispensing (and/or aspirating) systems and methods which can be efficaciously utilized in accordance with certain embodiments of the invention. All of these patent documents comprise a part of the present patent specification/application. In some embodiments, the low volume liquid handling system 310 comprises any one of the systems disclosed in the above-mentioned patent documents.

U.S. Pat. Nos. 6,063,339, 6,551,557 B1, 6,589,791 B1, and U.S. Patent Application Publication Nos. US 2002/0064482 A1, US 2003/0207464 A1, US 2003/0215957 A1, US 2003/0228241 A1, the entirety of each one of which is hereby incorporated by reference herein, disclose liquid dispensing (and/or aspirating) systems and methods which can be efficaciously utilized in accordance with certain embodiments of the invention. All of these patent documents comprise a part of the present patent specification/application. In some embodiments, the low volume liquid handling system 310 comprises any one of the systems disclosed in the above-mentioned patent documents.

Salt Selection (FIG. 30): A significant number of current therapeutics are delivered as salt forms (as opposed to the free base form). There are some estimates that place the percentage of salt-form medicines as high as 50%. Increasingly, pharmaceutical companies desire to conduct salt selection screening earlier in the drug development process in order to maximize their understanding of the chemical “landscape” for a given molecular entity. Because critical physico-chemical properties are heavily influenced by the salt form of a compound (e.g. melting point, morphology, hygroscopicity, powder flowability, etc.) establishing the knowledge of how the salt form performs in a drug product is critical in taking the best form of a compound into the clinic.

Typical salt selection screens involve re-crystallizing a particular compound from a variety of counter-ion solutions, as well as varying crystallization solvents and conditions. Depending on the specific approach taken, and the amount of compound available for a screen, anywhere from 10's to 1000's of unique combinatorial conditions are created and analyzed for the resulting salt form.

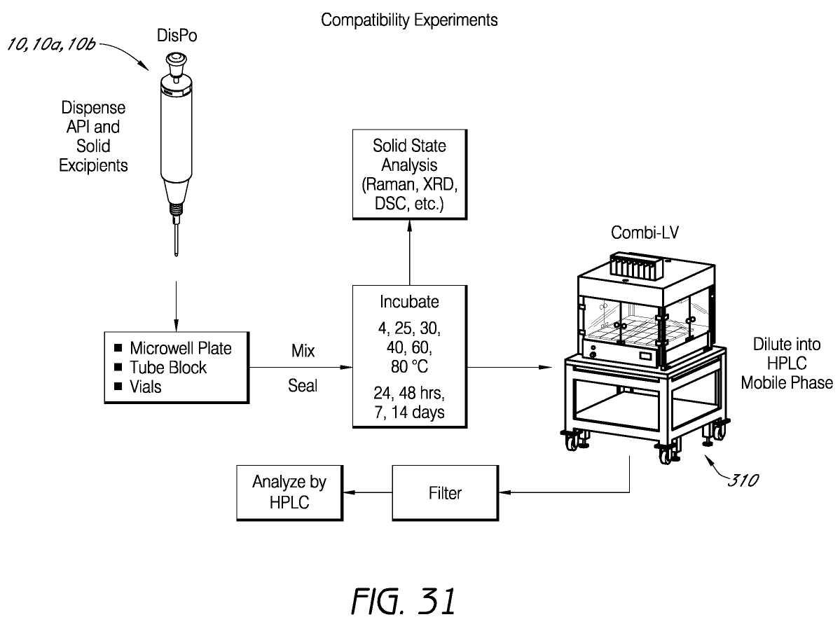

Compatibility Experiments (FIG. 31): In formulating a drug product there are many ingredients, or excipients, that are needed in addition to the drug substance itself. Of ten times there are incompatibilities between the drug substance and these excipients that lead to degradation and stability problems. Compatibility experiments involve adding the drug substance to the various excipients, at a variety of levels or concentrations, and exposing these mixtures to different environmental storage conditions (e.g. moisture, elevated temperature, etc). After mixing and exposure the amount of drug substance is determined (typically by HPLC—High Performance/Pressure/Purity Liquid Chromatography); any degradation indicates an incompatibility between the drug substance and the particular excipient(s). While these experiments can be conducted in the solution phase, the preferred experiment involves dealing with solid drug substance and neat excipients (either solid or liquid depending on the particular excipient).

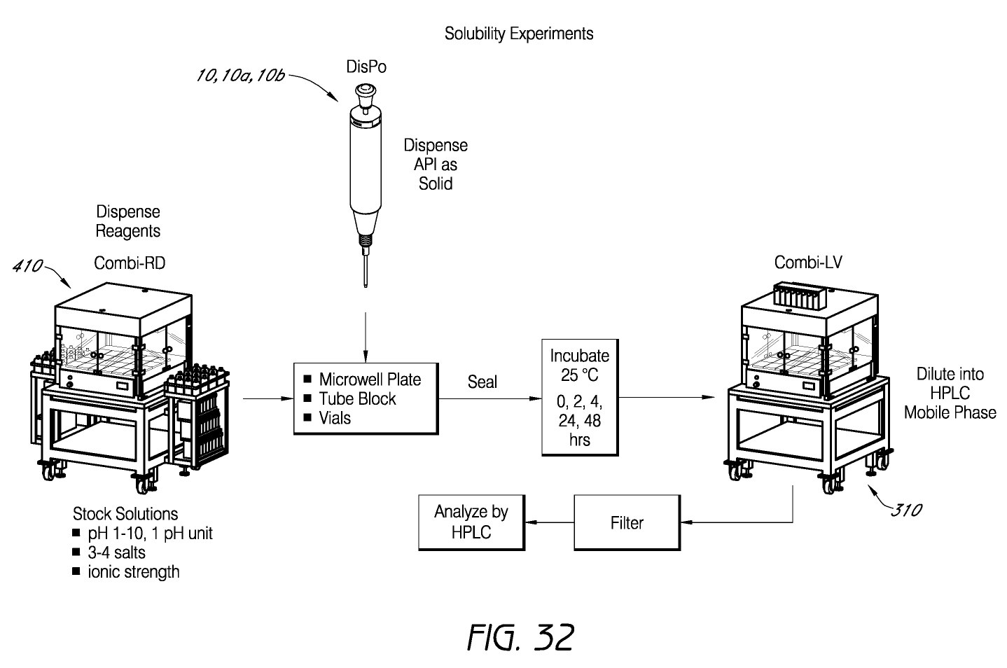

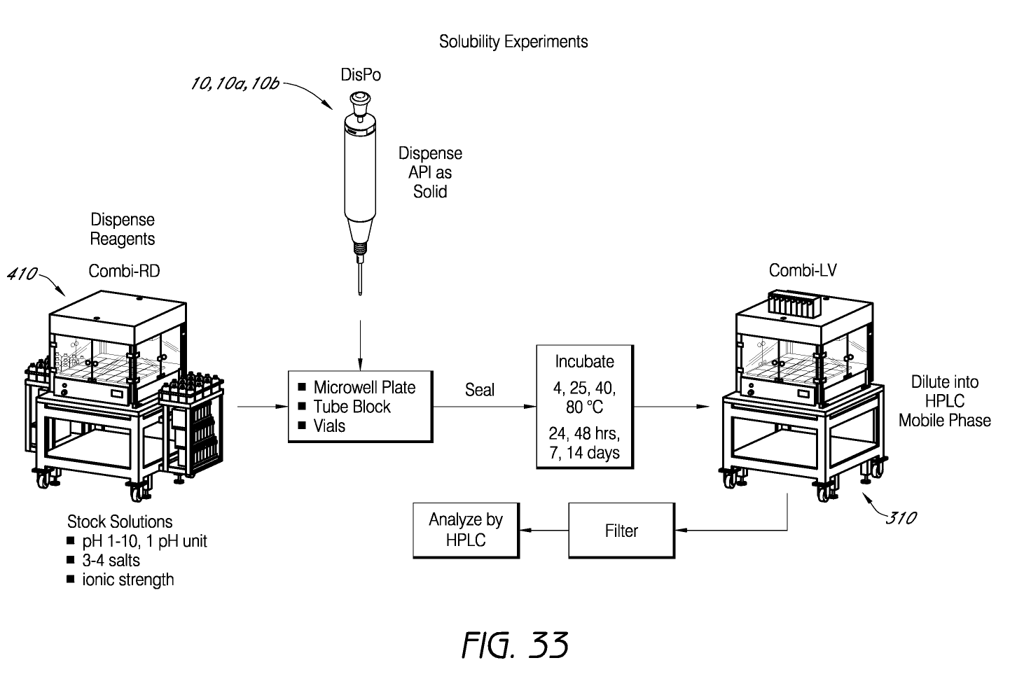

SolubilitE Experiments (FIGS. 32 and 33): A critical factor in developing a drug product is the chemical entities solubility in aqueous solution. Aqueous solubility is often measured in a variety of solutions that range in composition from low pH to high pH, or low ionic strength to high ionic strength. These experiments consist of adding a compound to a range of buffers, in a range of concentrations, and measuring the solubility of the compound (by UV absorbance, nephelometry or HPLC). The most desired way to carry out these experiments is to deliver the compound as a solid, so that the inherent solubility can be determined. However, due to the difficulty of delivering very small amounts of a variety of solid samples, most experiments are carried out by first dissolving the compound in a suitable solvent and then delivering as small a volume of liquid sample as possible to the buffer solutions. By minimizing the sample volume containing the compound one can minimize the enhanced solubility that he solvent gives the compound.

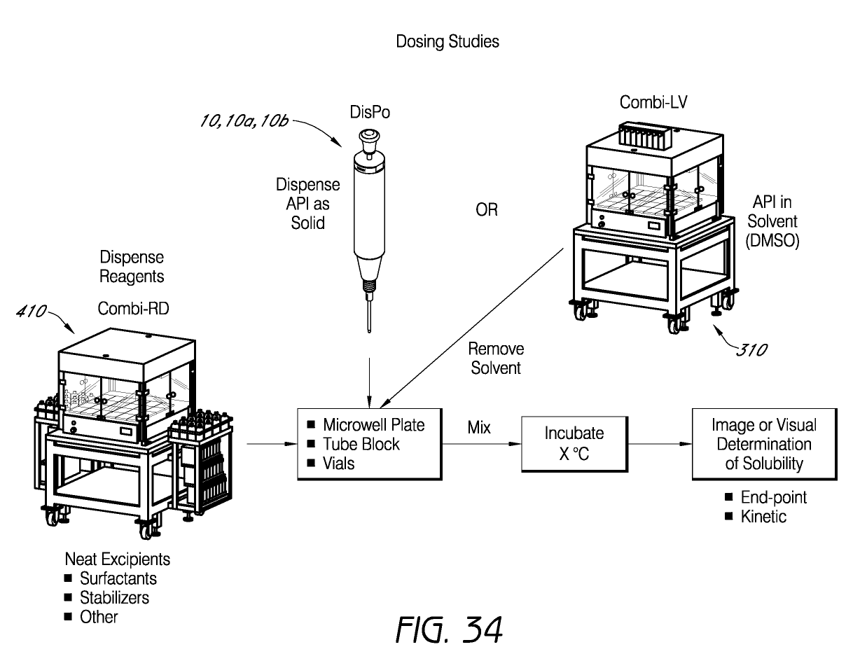

Dosing Studies (FIG. 34): Most animal dosing studies typically involve dosing compounds in suspensions. This is because there is often not a feasible or viable solution-based vehicle suitable for dosing. As a result there can be a discrepancy between the bioavailability measured in an animal dosing study and the inherent potential of a compound due to the dosing vehicle that is used. Dosing with solution-based vehicles (both aqueous and non-aqueous) allows for more accurate prediction of bioavailability and therefore provides a better chance to maximize the potential of a particular compound.

Dosing screens are typically conducted by creating a range of vehicles from both aqueous and non-aqueous excipients. These mixtures can be created through combinatorial means, or can be made up as simple ratios of ingredients. A common strategy is to create a “library” of vehicles and use this library as a screen for all compounds. Alternatively, a unique set of vehicles can be created for a particular compound based on the specific chemistry or functionality of the compound of interest. Once the compound has been added to the range of vehicles selection of the most suitable formulation is based on determining or estimating the compounds solubility in the vehicle. This can be accomplished either by quantitative measurement (e.g. HPLC) or by visual inspection for solubility (i.e. presence of un-dissolved compound or precipitation).

### Some Liquid and Reagent Handling Embodiments

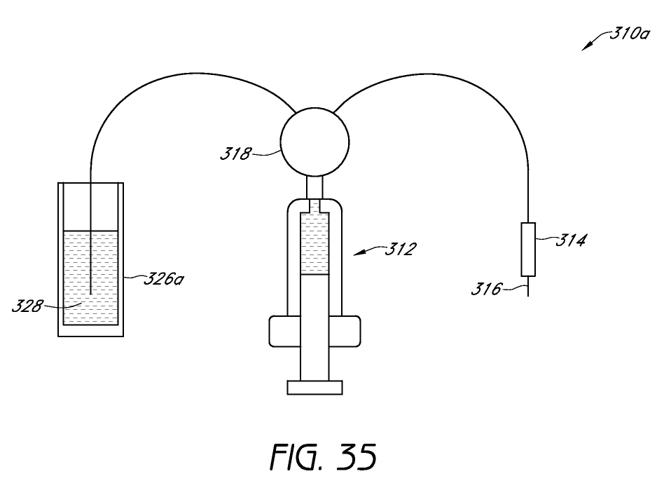

FIGS. 35 to 37 show certain embodiments of liquid handling systems 310 (310a, 310b) for low volume reagent aspirating and dispensing applications. In some embodiments, the systems 310 (310a, 310b) have been designed around BioDot's patented BioJet Plus technology (see www.biodot.com for more information on BioDot products). This technology brings low volume (i.e. nanoliter and picoliter range) non-contact liquid handling capabilities for use in conjunction with the powder handling systems disclosed herein. The BioJet Plus technology, in some embodiments, involves the combined use of a high resolution syringe pump that is precisely controlled and synchronized with a high speed drop-on-demand solenoid inkjet valve. Applications involving complex reagent mixtures, dispensed in a non-contact combinatorial fashion, are readily served by the systems 310 (310a, 310b). The non-contact dispense mode allows dispensing onto and into a wide variety of substrates. With the CX valve (e.g., as available from HOERBIGER of Switzerland, among others) option, a wide range of organic solvents can be handled with complete chemical compatibility. This can be particularly important in combinatorial materials discovery studies. The system 310 is also capable of operating in an aspiration mode in addition to bulk dispensing. This means that experiments can be conducted with as little as 10's of microliters or less of reagent. In some embodiments, the base system is configurable from a single BioJet Plus channel, up to as many as 96 individually controllable channels. There are optional heated fluid lines in order to extend the reagent dispensing range. The typical non-contact dispense volume range for the systems 310 (310a, 310b) is between, in one embodiment, 10 nanoliters (nL) and 5 μL, and in another embodiment, 1 nL or less and 1 μL, depending on the specific properties of the reagents being dispensed. The systems 310 (310a, 310b), in some embodiments, deliver these volumes to within 5% of the target volume with a reproducibility within 10% RSD for volumes less than about 100 nL and 5% for volumes greater than about 100 nL.

Some key benefits of the systems 310 (310a, 310b) include, without limitation: nanoliter and picoliter, non-contact dispensing allows low volume dispensing (e.g., supports advanced materials research programs), can be used in conjunction with multiple dispense modes (e.g., discrete drops and bursts of drops), and can create a variety of dispense patterns (e.g., drops, lines, and dashes, among others); multi-channel configuration for combinatorial applications, among others, flow-through dispense and aspirate/dispense modes (rheology dependent); several platform sizes and configurations to choose from; can be efficaciously combined with the reagent handling capabilities of the system 410.

Referring in particular to FIG. 35, in some embodiments, the system 310a generally comprises a stepper motor driven syringe or pump 312, in selective fluid communication with a micro solenoid valve 314 and a nozzle 316 via a switching valve 318. The syringe or pump 312 is also in selective fluid communication with, via the switching nozzle 318, a reservoir 326a containing a liquid or reagent 328 to be dispensed.

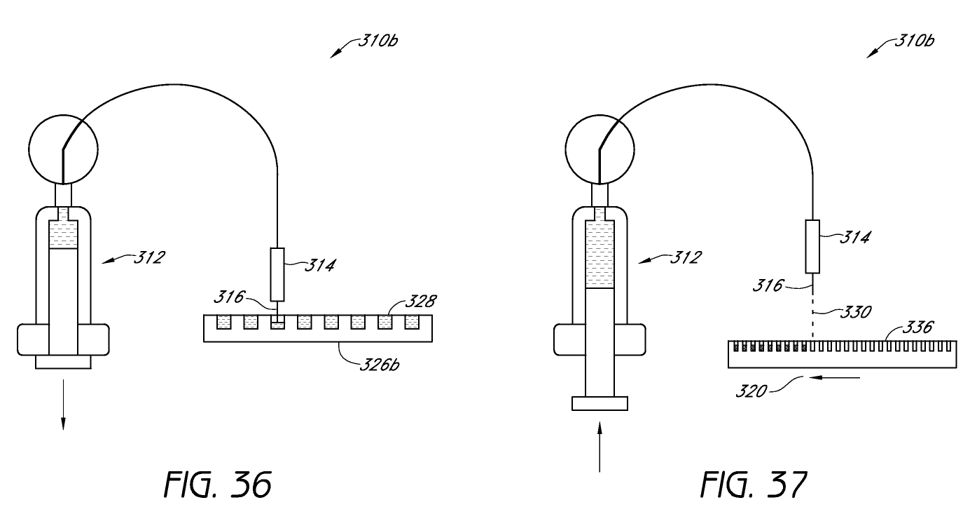

FIGS. 36 and 37 show certain embodiments of aspirate and dispense mode utilizing some embodiments of the system 310b. Sample 328 (from the source 326) is first aspirated into the fluid path by retracting the syringe 312 while the dispense nozzle 316 is submerged in the sample 328 of interest. After introducing or aspirating the liquid or reagent sample, the dispensing occurs via bulk dispensing in the form of one or more drops or droplets 330 of the liquid reagent 328 into or onto a target 336. Motion control can be provided by one or more robotic arms, tables or carriages such as the XY translation stage 320.

The methods which are described and illustrated herein are respectively not limited to the sequence of acts or steps described, nor are they respectively necessarily limited to the practice of all of the acts or steps set forth. Other sequences of acts or steps, or less than all of the acts or steps, or simultaneous occurrence of the acts or steps, may be utilized in practicing embodiments of the invention.

It is to be understood that any range of values disclosed, taught or suggested herein comprises all values and sub-ranges therebetween. For example, a range from 5 to 10 will comprise all numerical values between 5 and 10 and all sub-ranges between 5 and 10.

From the foregoing description, it will be appreciated that a novel approach for solid powder handling or manipulation has been disclosed. While the components, techniques and aspects of the invention have been described with a certain degree of particularity, it is manifest that many changes may be made in the specific designs, constructions and methodology herein above described without departing from the spirit and scope of this disclosure.

While a number of preferred embodiments of the invention and variations thereof have been described in detail, other modifications and methods of using and other materials discovery, development and optimization, and life sciences, biotech, pharmaceutical, diagnostic, medical, chemical, biological and/or agricultural applications for the same will be apparent to those of skill in the art. Accordingly, it should be understood that various applications, modifications, and substitutions may be made of equivalents without departing from the spirit of the invention or the scope of the claims.

Various modifications and applications of the invention may occur to those who are skilled in the art, without departing from the true spirit or scope of the invention. It should be understood that the invention is not limited to the embodiments set forth herein for purposes of exemplification, but is to be defined only by a fair reading of the claims, including the full range of equivalency to which each element thereof is entitled.

What is claimed is:

1. A handheld powder handling device, comprising:
a surface configured to be held by a user during operation of the device;
a tip comprising a lumen and an orifice at an end thereof;
a push button configured to be actuated by the user; and
a plunger operatively coupled to the push button and being moveable within the lumen;
wherein motion of the surface relative to the plunger causes a predetermined amount of powder to be loaded within the lumen and motion of the plunger relative to the surface causes the powder to be ejected from the orifice.

2. The device of claim 1, wherein the lumen has a predetermined powder fill volume.

3. The device of claim 2, wherein the powder fill volume is determined by the volume between the orifice and a stationary distal end of the plunger.

4. The device of claim 2, wherein the powder fill volume is adjustable.

5. The device of claim 4, wherein the powder fill volume is adjustable by a thumb wheel.

6. The device of claim 1, wherein the tip is removable.

7. The device of claim 6, wherein the tip is reusable.

8. The device of claim 6, wherein the tip is disposable.

9. The device of claim 1, wherein the surface comprises an outer ergonomically contoured surface.

10. The device of claim 1, wherein the surface is operatively coupled to a spring that at least partially controls the motion of the surface.

11. The device of claim 1, wherein the plunger is operatively coupled to a spring that at least partially controls the motion of the plunger.

12. The device of claim 1, wherein the device further comprises an ejection rod that couples the push button and the plunger.

13. The device of claim 1, wherein the powder has a mass in the range from about 1 microgram (μg) to about 1,000 milligrams (mg).

14. The device of claim 1 in combination with at least one more handheld powder handling device with a different tip size to form a kit.

15. The device of claim 1, in combination with at least one more tip with a different size to form a kit.

16. A method of handling a powder using a handheld device, comprising:
manually holding a surface of the device;
inserting a tip of the device in a powder source;
pushing the surface so that it moves relative to the tip and so that a predetermined quantity of powder is loaded in the tip;
manually actuating a plunger of the device so that it moves within the tip to eject the predetermined quantity of powder from the tip onto or into a target.

17. The method of claim 16, wherein the method further comprises manually moving the device from the powder source to the target.

18. The method of claim 16, wherein the method further comprises adjusting the device and delivering a different predetermined quantity of the powder.

19. The method of claim 16, wherein manually actuating a plunger comprises depressing a button that is operatively coupled to the plunger.

20. The method of claim 16, wherein manually actuating a plunger comprises moving the plunger relative to the surface.
